(19) United States
(12) Patent Application Publication
(10) Pub. No.: US 2023/0052887 A1
(43) Pub. Date: Feb. 16, 2023

(54) Robotic Platforms and Robots for Nondestructive Testing Applications, Including Their Production and Use

(71) Applicants: Erin Hong, Northridge, CA (US); Christoph Schaal, Tujunga, CA (US)

(72) Inventors: Erin Hong, Northridge, CA (US); Christoph Schaal, Tujunga, CA (US)

(21) Appl. No.: 17/676,172

(22) Filed: Feb. 20, 2022

Related U.S. Application Data
(63) Continuation-in-part of application No. 16/366,383, filed on Mar. 27, 2019, now abandoned.
(60) Provisional application No. 62/742,381, filed on Oct. 7, 2018.

(51) Int. Cl. B25J 9/16

(52) U.S. Cl. CPC B25J 9/1664

(57) ABSTRACT

Robotic platforms and methods of use are disclosed that include: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method.

This Continuation in Part Patent Application claims priority to U.S. Utility patent application Ser. No. 16/366383, which claims priority to U.S. Provisional Application Ser. No. 62/742,381 filed on Oct. 7, 2018, which is entitled “Robotic Platforms and Robots for Nondestructive Testing Applications, Including Their Production and Use” all of which are incorporated by reference herein in its entirety.

### FIELD OF THE SUBJECT MATTER

The field of the subject matter is robotic platforms and robots for nondestructive testing applications, including their production and uses thereof.

### BACKGROUND

While airplanes are regularly considered one of the safest methods of travel, this is, to a large extent, due to tremendous design and maintenance efforts. Airplanes are in service for very long periods, often longer than originally planned, due to the high costs of new airplanes. During maintenance periods, visual inspection is performed and in rare cases with special equipment such as X-ray technology. However, visual inspection is limited to the detection of surface flaws, and X-rays are dangerous and costly. While these strategies have still been used for many years for conventionally designed aircrafts, with modern composite components, visual inspection is no longer adequate because defects are often hidden from the outside. In order to prevent growth of potentially existing defects inside the airplane components, segments are often preemptively replaced after certain flight intervals. With nondestructive testing (NDT) methods, such defects could be detected at an early stage, thus preventing catastrophic failure and eliminating the unnecessary replacement of intact components. Research has shown that guided ultrasonic wave-based methods allow for finding damages in complex composite components (e.g. [1,2]). However, it is important to localize damages with respect to other features in order to obtain a complete analysis and generate recommendations for maintenance. Hence, it is important to identify all features of the structure and generate a map, including any damages. This has not been addressed in detail in the literature yet.

Nondestructive testing (NDT) are methods to inspect specimens without destroying or disassembling the physical specimen. In the method used in this work, guided ultrasonic waves are transmitted into a structure, and the received waves may be altered, thus showing information about a defect or anomaly in its path. Additionally, NDT can be used for detecting structural geometries. This information can be used to generate maps of the structure, including the damage locations and structural boundaries. Currently, NDT is mostly conducted manually by human operators. If a robot is able to take NDT measurements and analyze the data to generate a map, the robot can reverse engineer the structure, detect damages, and use the information to focus on the affected area or call attention to an operator for closer inspection. In this work, a robot is designed and developed for the purpose of including an NDT module to conduct measurements on aluminum and composites plates. Additionally, a path planning algorithm is implemented on an off-the-shelf robot platform with an indoor navigation system to demonstrate the viability of autonomous drive without using GPS. Finally, NDT experiments are conducted to detect structural boundaries of the plates and the stiffened area. The various aspects of this work are for the eventual integration and development of a robot platform to automate the NDT process. An application of using NDT for mapping is to check airplane wings for defects during their maintenance sessions, in which case the stiffeners and ribs inside the wings can be located and checked against (a priori) engineering drawings.

For nondestructive testing, ultrasonic waves are transmitted into a specimen using a transducer. Surfaces and structural features of the specimen can restrict the movement of the waves, in which case these features are considered to be “wave guides.” In this work, the test specimens are thin plates, so the top and bottom surfaces of the plate are guiding waves. Such Lamb waves consist of symmetric and antisymmetric modes.[23] Lamb waves have fundamental modes of A₀ and S₀ but have an infinite number of modes. These modes only exist at certain frequencies and each mode has different group and phase velocities, so it is necessary to refer to group and phase velocity dispersion plots. Group velocity of the wave group is the propagation velocity, and phase velocity is the velocity of an individual wave. These dispersion plots will be necessary for further analysis.

Lamb wave propagation in isotropic plates as well as in more complex media, e.g. isotropic multi-layered plates, have been studied by numerous authors (e.g. [3, 4, 5]). Furthermore, it has been shown that damages in complex composite components can be identified using Lamb wave-based techniques, in particular the detection of delaminations between individual plies [1, 2, 6, 7, 8]. While NDT methods have generally been used to detect failures in a structure, they can also be used to detect structural geometries [9]. For example, an incident wave reflects at free ends generally without any mode conversion if the excitation frequency is below the first cut-off frequency [9, 10, 11, 12, 13]. Above this frequency, it has been shown how obliquely incident Lamb waves from a free end can scatter into multiple waves Santhanam and Demirli [14]. If the reflected waves are recorded, edges and step discontinuities may be localized through a time-of-flight analysis. In order to apply a time-of-flight analysis of the measured waves, the dispersion behavior has to be well-understood. For this purpose, many different (numerical) techniques have been developed [15, 16, 17, 18] to determine the Lamb wave propagation characteristics in isotropic and anisotropic materials.

For the purposes of this information, the specimen is assumed to be of an unknown size, for which the edges and stiffened area are to be determined. Piezoelectric transducers are set up in a pitch-catch configuration in locations on a grid along a stiffened plate. As shown in FIG. 1, induced ultrasonic Lamb waves are scattered at the edges of the plate as well as at the stiffener. Furthermore, waves propagating through the stiffened region are altered due to the change in geometry. From the measured signals, the locations of the first reflections are determined through a time-of-flight analysis, and the edges of the plate are determined. By detecting the change in the waves due to the stiffener, the region of the stiffener can be identified as well. Thus, the developed algorithm can generate a map of the plate with its expected edges and area of the stiffener. Existing defects could be identified in a similar way, and marked accordingly in the generated map, thus leading to a complete damage detection and localization.

### SUMMARY OF THE SUBJECT MATTER

Robotic platforms are disclosed that include: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method.

Other contemplated embodiments comprise a robotic platform that includes: at least one robot or robotic device, wherein the at least one robot or robotic device comprises a sensor for cliff detection, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

Yet other contemplated embodiments comprise a robotic platform that includes: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

Methods of evaluating a surface include: providing a robotic platform that comprises: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method; providing a structure to be tested; and utilizing the robotic platform to evaluate the structure through the implementation of at least one nondestructive testing method.

### BRIEF DESCRIPTION OF THE FIGURES AND TABLES

As shown in FIG. 1, induced ultrasonic Lamb waves are scattered at the edges of the plate as well as at the stiffener.

FIGS. 2A-2D shows a contemplated laboratory setup for contact transducer experiment: used coordinate system, Plexiglas fixture, and transducers

FIG. 3A and 3B shows the excitation signal from waveform generator and reference face-to-face measurement from oscilloscope to identify time delays for contact transducer experiment.

FIGS. 4A and 4B shows visualization of the applied signal processing algorithms for edge and stiffened area detection.

FIGS. 5A and 5B shows sample signals from the stiffened plate captured for the edge detection, where the horizontal dashed line is the user-set threshold, and dotted vertical lines are expected peak times (left: S0, right: A0).

FIGS. 6A-6C shows an edge-detection map for the stiffened plate: possible reflections from edges are marked red, area in which transducers are placed is marked yellow (center square). The black outline indicates the actual edges of the plate.

FIGS. 7A and 7B shows sample signals captured for the stiffener detection, showing an earlier arrival time for transducer pairs located across the stiffener.

FIG. 8 shows a stiffener-detection map, where the yellow patch (middle square) indicates the actual location of stiffener.

FIG. 9 shows high level logic of the robot's path planning algorithm.

FIGS. 10A and 10B shows a transmitter mode: the robot first travels to the point closest to its starting position and offset by distance L. Then, the robot turns in place until the transmitter is at the desired location. The final orientation of the transmitter is negligible. Sketches are not to scale.

FIGS. 11A and 11B shows a receiver mode: the robot first travels to the point that is located d and L from the transmitter location. Then, the robot turns in place until the receiver is in the desired location. The orientation of the receiver must be facing towards the transmitter. Sketches are not to scale.

FIG. 12 shows a box plot illustrating the spread of the final positions with and without the positional Kalman Filter (KF). The red line indicates the median value, and the bottom and top edges of the boxes mark the 25th and 75th percentiles, respectively. The whiskers extend to the most extreme values that are not considered outliers, and the red ‘+’ symbol indicates the outliers [2].

FIG. 13 shows a screen capture of robot's telemetry plotted in MATLAB: hedgehog position in coordinate system (left), forward direction of robot (blue arrow), KF position (green ∘), target (red ×), and beacons (blue *); distance error between the robot and the target (top right); and angle error between the forward vector and target (bottom right).

FIG. 14 shows a box plot illustrating the spread of the final positions with and without the angular Kalman Filter (KF). The red line indicates the median value, and the bottom and top edges of the boxes mark the 25th and 75th percentiles, respectively. The whiskers extend to the most extreme values that are not considered outliers, and the red ‘+’ symbol indicates the outliers [2].

FIGS. 15A and 15B shows NDT circuits: schematics for the module in transmission and receiving modes based on work by Pertsch et al. [3]. Courtesy of Rozmari Babajanian.

FIG. 16 shows an inversely proportional relationship between distance and voltage amplitude: as the transducers are placed farther away from each other, the received signal is weaker.

FIG. 17 shows a goniometric stage (or goniometer): the surface of the goniometric stage rotates about a fixed point in space (marked by the circles on the plate). On the left, the goniometer's surface is parallel to the plate and at 0° of rotation (notated with the small tick mark in the center). On the right, the surface has been rotated by θ=10°.

FIG. 18 shows an air-coupled transducer experiment set up, where the transducers are mounted to goniometers rotated to the desired angles.

FIG. 19 shows an illustration of Snell's Law with ultrasonic wave passing through interface be- tween air and aluminum.

FIG. 20 shows a block diagram of NDT module: PA is the power amplifier, LNA is the low noise amplifier, PGA is the programmable gain amplifier, and ND is the analog-to-digital converter. The dashed lines denote connections to batteries.

FIG. 21 shows a diagram of location of probe locations, where signals are recorded by oscilloscope (1-4) and the microcontroller (5).

FIGS. 22A and 22B show recorded data of transmitted signals from Probes 1 and 2.

FIG. 23 shows sample signal that is averaged over four captures.

FIG. 24 shows a power spectrum of excitation signal generated from NDT module.

FIGS. 25A and 25B show magnitude and phase responses of low-pass filter, in which the pass frequency is set to f=250 kHz and stop frequency is set to f=300 kHz.

FIGS. 26A and 26B show recorded data of transmitted signals from Probe 3.

FIGS. 27A and 27B show recorded data of received signals from Probe 4.

FIG. 28 shows recorded data of received signal (converted via ADC) from Probe 5.

As disclosed and discussed in the Examples Section, once the measurement is taken, the data is post processed and analyzed using the NDT algorithms to map the structure (currently, rectangular plates). FIG. 29 shows a flow chart for this process.

The NDT module consists of an air-coupled transducer and circuitry for either transmission mode, receiver mode, or both. The module is developed from off-the-shelf components and the circuits are based off work by Pertsch (see FIG. 30).

FIGS. 31A and 31B shows schematics of experimental setups self-localization and feature detection.

FIGS. 32A and 32B shows signal comparison of guided Lamb waves going over an unstiffened and stiffened area. Utilizing geometric spreading, power loss due to a stiffener becomes visible.

FIGS. 33A and 33B show a prototype mobile robotic platform for automated guided wave-based NDT.

FIGS. 34A and 34B shows a prototype NDT circuitry for inducing and measuring guided ultrasonic waves from a mobile robotic platform.

FIGS. 35A and 35B shows a comparison of measurements with PCB test circuitry versus base signal and laboratory equipment.

FIGS. 36A and 36B shows results from the feature extraction and k-means clustering for one sample measurement set.

FIG. 37 shows the intersection of all anomaly maps resulting in approximate location and width (in rectangle) of the stiffener based on measurements with three stationary transducer locations (+).

FIG. 38 shows the results of the localization and edge detection experiment. Each actuation cluster center (∘) is used to predict the location of the sensor (+) and edge (x).

### DETAILED DESCRIPTION

Nondestructive testing (NDT) are methods to inspect specimens without destroying or disassembling the physical specimen. In the method used in this work, guided ultrasonic waves are transmitted into a structure, and the received waves may be altered, thus showing information about a defect or anomaly in its path. Additionally, NDT can be used for detecting structural geometries. This information can be used to generate maps of the structure, including the damage locations and structural boundaries.

Ultrasound sensor technology has a myriad of uses in robotics. Mobile robots are used for traversing terrains as planetary rovers, as hotel butlers, or as vacuum cleaners. For these kinds of mobile robots, ultrasound is the conventional technology used for mapping, navigation, obstacle avoidance, and localization. In medicine and healthcare, the most familiar application of ultrasound is sonography, showing objects inside the body.

Robots can autonomously conduct ultrasound examinations, replacing physicians who are likely to experience repetitive strain injuries [4]. Similarly, ultrasound can be used for nondestructive testing (NDT), for which a specimen can be inspected for damages without destroying or disassembling the original shape. Guided waves are transmitted by a transducer through air or a structure, and, by the time-of-flight principle, the received signal can show if there is an obstacle or defect in the waves' paths.

It is important to study ultrasound sensor technology because of its applications, especially in autonomous systems. Autonomous mobile robots can use ultrasound sensors for navigation and mapping as well as localization. To build a map for navigation, the robot can use the ultrasound waves to detect and remember the robot's environment. Localization is the process of identifying its location within the map and environment. With these two functions, an autonomous robot is able to determine where it is currently is located within the map, where it can go, and how it can get there.

While airplanes are regularly considered one of the safest methods of travel, this is, to a large extent, due to tremendous design and maintenance efforts. Airplanes are in service for very long periods, often longer than originally planned, due to the high costs of new airplanes. During maintenance periods, visual inspection is performed and in rare cases with special equipment such as X-ray technology. However, visual inspection is limited to the detection of surface flaws, and X-rays are dangerous and costly. While these strategies have still been used for many years for conventionally designed aircrafts, with modern composite components, visual inspection is no longer adequate because defects are often hidden from the outside. In order to prevent growth of potentially existing defects inside the airplane components, segments are often preemptively replaced after certain flight intervals.

Ultrasound also has been used in NDT of structures, such as airplane wings, in which ultrasonic waves are transmitted into a specimen using a transducer. Surfaces and structural features of the specimen can restrict the movement of the waves, in which case these features are considered to be “wave guides.” Lamb waves exist in thin plates and have symmetric and antisymmetric modes. The fundamental modes are A₀ and S₀, and the modes exist at certain frequencies. They can also convert from symmetric to antisymmetric, and vice versa [5].

Since defects can develop inside the wing during use, it is important to conduct tests during maintenance periods when the airplane is in the hanger. It is impractical to disassemble the wing to do this because of the time and complexity of disassembling, testing, and reassembling for the next flight. However, it is impossible to visually see all the defects from the surface. While there may be external scratches and cracks seen from the outside, the defects that NDT can detect include cracks from fatigue in metals, delamination in composite materials, or even the results of impacts from bird or drones. With NDT methods, such defects could be detected at an early stage, thus preventing catastrophic failure and eliminating the unnecessary replacement of intact components. For example, after the Southwest Airlines tragedy, the FAA requires ultrasonic NDT for engine fan blades.

Currently, ultrasound testing is conducted by an operator and only in through-thickness mode, which takes a long time and also depends on the operator's skill. By automating this process with robots to take measurements using guided waves from the same surface, the testing time can be reduced, and the human error element can also be removed. Hence, it is important to develop an autonomous robot that can automate the NDT process; this requires a robotic platform that can navigate around a test structure, an NDT module onboard such that it can conduct the tests, and algorithms to conduct NDT, analyze the data to identify features and generate a map including any damages.

Currently, NDT is mostly conducted manually by human operators. If a robot is able to take NDT measurements and analyze the data to generate a map, the robot can reverse engineer the structure, detect damages, and use the information to focus on the affected area or call attention to an operator for closer inspection. At least one robot is designed and developed for the purpose of including an NDT module to conduct measurements on aluminum and composites plates. Additionally, a path planning algorithm is implemented on an on-the-shelf robot platform with an indoor navigation system to demonstrate the viability of autonomous drive without using GPS.

Research has shown that guided ultrasonic wave-based methods allow for finding damages in complex composite components (e.g. [1, 2]). However, it is important to localize damages with respect to other features in order to obtain a complete analysis and generate recommendations for maintenance. Hence, it is important to identify all features of the structure and generate a map, including any damages. Through the use of contemplated nondestructive testing (NDT) methods, such defects as those described herein could be detected at an early stage, thus preventing catastrophic failure and eliminating the unnecessary replacement of intact components.

A contemplated automated robot is a robotic platform designed and implemented to conduct nondestructive testing (NDT), methods already described herein that are used to evaluate a structure for damages that cannot be visually detected from the surface. It is capable of driving autonomously with its path planning algorithms. The platform includes an NDT module with which measurements can be taken on the structure that it is testing. In addition to determining damages in the specimen, the data is used for edge detection and stiffener detection, which can generate a map of the specimen as well as the damages located within.

Specifically, an automated robot platform is described herein that includes: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method. In contemplated embodiments, the at least one communications system is designed to communicate remotely between the at least one robot and either home base and/or the user.

Contemplated robotic platforms comprise at least one communications system, wherein the at least one communications system is designed to communicate remotely between the at least one robot and a home base component, a user, or a combination thereof.

Contemplated robotic platforms and systems further comprise a structure that is separate and independent from the robotic platform, wherein the structure has at least one surface.

Contemplated robotic platforms comprise at least one evaluation system, wherein the at least one evaluation system evaluates the structure for at least one damaged area, at least one defect, or at least one additional structural problem that cannot be visually detected from the surface of the structure. In some contemplated embodiments, the at least one evaluation system collects measurements on the structure. In other contemplated embodiments, the at least one evaluation system conducts nondestructive tests on the structure. In contemplated embodiments, the at least one evaluation system collects at least one data point that will be used to produce a map of the structure. Contemplated maps of the structure shows at least one edge, at least one defect, at least on damaged area, at least one additional structural problem, or a combination thereof. In yet other contemplated embodiments, the at least one evaluation system collects at least one data point that will be used for stiffener detection on the surface. Contemplated at least one additional structural problem comprises a structurally weak area, an area that comprises an undesirable or unsuitable material, or a combination thereof.

Contemplated robotic platforms comprise at least one computer-based control system, wherein the at least one computer-based control system comprises at least one path-planning algorithm. In some contemplated embodiments, the at least one path-planning algorithm directs the at least one computer-based control system to drive the at least one robot or robotic device autonomously.

Contemplated embodiments of the at least one robot comprises a wheeled robot or a robot that is mobile by any other suitable means or methods. In some contemplated embodiments, the at least one robot comprises at least one sensor.

In addition, methods of evaluating a surface include: providing a robotic platform that comprises: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method; providing a structure to be tested; and utilizing the robotic platform to evaluate the structure through the implementation of at least one nondestructive testing method.

Other contemplated embodiments comprise a robotic platform that includes: at least one robot or robotic device, wherein the at least one robot or robotic device comprises a sensor for cliff detection, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

Yet other contemplated embodiments comprise a robotic platform that includes: at least one robot or robotic device, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

In other embodiments, methods of evaluating a surface comprise: providing a robotic platform that comprises: at least one robot or robotic device, wherein the at least one robot or robotic device comprises a sensor for cliff detection, at least one computer-based control system, wherein the system is at least in part located on the at least one robot, at least one communications system, wherein the communications system is designed to communicate between the computer-based control system and the at least one robot, and at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure; providing a structure to be tested; and utilizing the robotic platform in direct contact with the surface to evaluate the structure through the implementation of at least one nondestructive testing method.

With respect to contemplated embodiments, the at least one robot may comprise a wheeled robot or a robot that is mobile by any other suitable means or methods. Contemplated robots are capable of being controlled remotely by a user and serves as the eventual platform for a fully integrated NDT, mapping, and path planning system. The autonomous drive and path planning algorithms are implemented on an iRobot Create 2 wheeled robot platform. In addition to its basic setup, additional sensors (e.g. inertial measurement unit and indoor navigation system) are added to execute path planning. It is outfitted with an NDT module to perform NDT experiments as a transmitter or receiver. The NDT module demonstrates the proof-of-concept that NDT can be conducted without using benchtop instrumentation and eventually with robots.

NDT experiments are conducted and disclosed herein to detect structural boundaries of the plates and the stiffened area. The various aspects disclosed are for the eventual integration and development of a robot platform to automate the NDT process. An application of using NDT for mapping is to check airplane wings for defects during their maintenance sessions, in which case the stiffeners and ribs inside the wings can be located and checked against (a priori) engineering drawings.

Contemplated robotic platforms can be developed—in whole or in part—from off-the-shelf components, as well as from in-house designed and manufactured parts. In at least one contemplated embodiment, the overall envelope dimensions are 6″ by 6″ by 6″. In at least one contemplated embodiment, the at least one robot comprises three wheels, two of which are driven, and one is a free-rolling wheel (e.g. castor wheel). There may be multiple sensors on the at least one robot, which may comprise infrared cliff sensors located at the front and rear of the robot, ultrasonic rangefinders to detect obstacles in front of the robot, an inertial measurement unit (IMU), and an indoor navigation system.

Contemplated robots may be controlled by a microprocessor (e.g. Raspberry Pi) for its high-level controls and a microcontroller (e.g. Arduino) for its low-level controls and sensor hub. Additionally, there is an NDT module, which may include a transducer that is mounted to the side of the robot chassis. A contemplated robot travels using its path planning algorithms, which navigate the transducer to a target location, where it can perform the contemplated nondestructive testing.

As disclosed and discussed in the Examples Section, once the measurement is taken, the data is post processed and analyzed using the NDT algorithms to map the structure (currently, rectangular plates). FIG. 29 shows a flow chart for this process.

For edge detection, the peak of the second wave packet is considered. Using the time-of-flight (TOF) principle, the reflection path distance can be evaluated. There are four possibilities for each measurement since the data is nondirectional. By using trigonometry, the possible reflection locations can be determined and plotted to generate an edge map. Then, line-fitting techniques are used to finalize the experimental edge of the specimen.

For stiffener detection, the peak of the first wave packet is considered. Similarly, using TOF, the distance of the direct path is calculated. The smallest values are used to plot the stiffened area. Currently, this method gives a general region of where the stiffener is located but further analysis using previously excluded data can present the true location with higher resolution.

The NDT module consists of an air-coupled transducer and circuitry for either transmission mode, receiver mode, or both. The module is developed from off-the-shelf components and the circuits are based off work by Pertsch (see FIG. 30).

An air-coupled transducer is mounted to a goniometer for accurate angular positioning. For the transmission/ amplification circuit, a pulser board is used to transmit the signal, which is programmed through a software interface. The transducer is connected to the board and transmits the signal into the specimen. On the receiving side, a conditioning board is designed off of the work by Pertsch. Then, the filtered signal is passed to a microcontroller, which has an analog-to-digital (ADC) converter.

This robot is able to drive autonomously to user-defined waypoints, has an NDT module with an ultrasonic transducer, and relevant circuitry to conduct NDT. The NDT measurements are taken from the same surface (instead of the through-thickness method). By using Lamb waves, the waves are able to travel farther distances and cover more space, thus reducing the time for inspection. Additionally, the edge and stiffener detections algorithms analyze the NDT data to generate a map for the robot to localize itself and locate any damages or structures within the same map.

Currently, many NDT processes are manually performed by a human operator, which takes much time and includes variability depending on the operator. By automating the process, the time to take measurements, labor costs, and error and variability decreases. Additionally, by building its own map, the robot is able to localize itself on any specimen without the need for an a priori map in its system but can compare its map to an existing map or engineering drawing of the specimen.

### EXAMPLES

### Example 1

### Guided Ultrasonic Wave Propagation and Scattering in Plates

For the successful application of ultrasonic NDT, precise knowledge of wave propagation characteristics for the structure at hand is crucial. For a homogeneous, isotropic, linearly elastic plate, the Lamb wave dispersion relations are also well known and are typically separated into symmetric and anti-symmetric wave motion [19, 20]. In addition to a finite number of real roots (corresponding to propagating waves) at a given frequency, the dispersion equations also have an infinite number of complex roots. Some of these roots are purely imaginary while others have both real and imaginary parts. The imaginary roots are associated with non-propagating waves while the complex roots give rise to evanescent waves, which propagate and decay with distance. The significance of the complex roots in the near-field of real and virtual sources has previously been addressed [9, 10, 11]. However, as in this paper, measurements are assumed to be taken in the far-field, and only propagating waves are considered.

Though it has been shown that mode conversion can generally occur from oblique incident waves at free edges by Santhanam and Demirli [14], this only has to be considered above the first cut-off frequency. Hence, in order to simplify signal processing, in this work, waves are induced well below below the first assumed cut-off frequency. On the other hand, Lamb waves generally reflect, transmit, and convert at stiffeners. In addition, waves propagating through the stiffened region are likely to be altered due to a change in propagation velocities. As has been shown by Schaal et al., there are two possibilities: the stiffened region either forms a new, thicker waveguide (strong bonding), or waves propagate separately in the base plate and the stiffener (weak bonding). In this work, it is assumed that the stiffener is strongly bonded to the base plate, and the stiffened region forms a new, thicker waveguide, altering the wave velocities accordingly.

### Experimental Setup

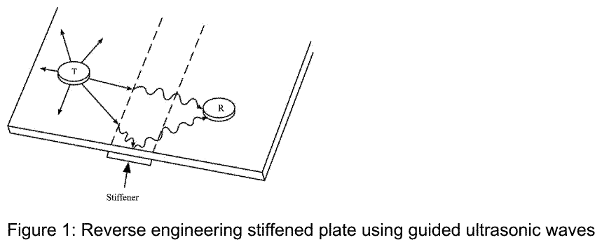

The general experimental setup is shown in FIG. 2. The investigated specimen is a 6061-T6 aluminum plate (558.8 mm×606.9 mm×3.161 mm). A grid is drawn on the surface of the specimen to provide a coordinate system for the transducer locations (see FIG. 2a). The origin is located at the lower left corner, and the first vertical line is drawn at 25 mm and first horizontal line is drawn at 20 mm. The subsequent lines are drawn at 50 mm and 40 mm intervals, respectively.

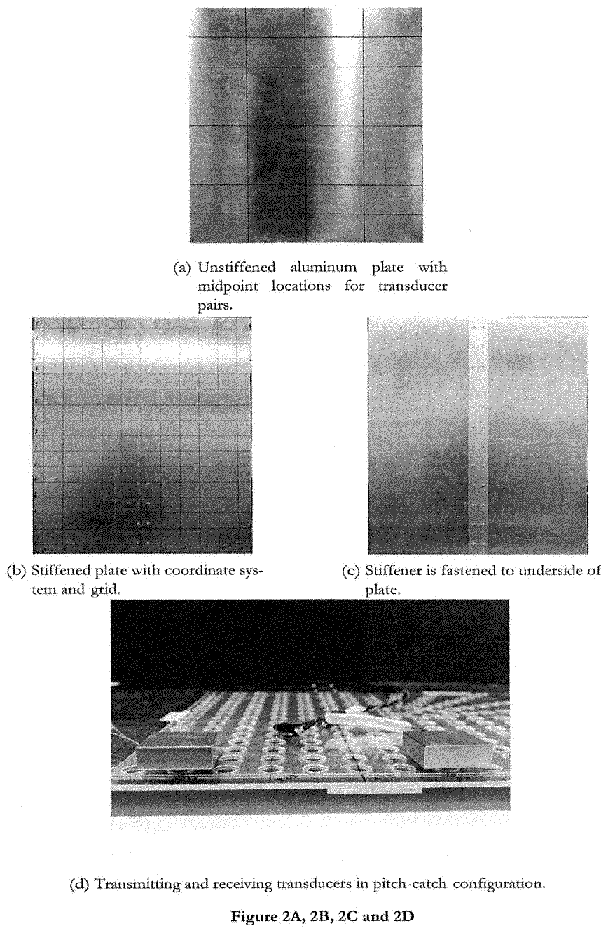

In order to induce guided Lamb waves in the investigated plate structures, a transient signal is generated by a waveform generator (Keysight 33512B). The signal consists of a 3-cycle Hann-windowed sinusoidal tone burst at f=150 kHz, as shown in FIG. 3A. Custom piezoelectric discs (approx. 12 mm diameter and 2 mm thickness) are placed on the surface of the specimen to induce the ultrasonic waves. Measurements are taken with another identical piezoelectric disc that is connected to an oscilloscope (Cleverscope CS320A). Signals are recorded for 350 μs in order to ensure that all relevant reflected waves are captured. A Plexiglas face sheet with an array of holes is used for precisely positioning the transmitting and receiving transducers, as shown in FIG. 2b. Through the application of an ultrasonic gel, the transmission of ultrasound from the transducers to the plate. It is found that mostly A₀ waves are induced at this frequency and with the used transducers. Time averaging of multiple repeated signals is performed in order to achieve a higher signal-to-noise ratio. Finally, signal processing is conducted in MATLAB.

For the first measurements, the transmitting disc is placed at (25, 20) and the receiving disc is placed at (175, 20), which yields a direct path length of 150 mm. It should be noted that all lengths are in millimeters unless otherwise specified. Then, the transmitter remains in place while the receiver is moved to (175, 60). Next, the transmitter is moved to (25, 60), and the receiver takes measurements from three locations: (175, 20), (175, 60), and (175, 100). This pattern is continued for new x coordinates of the transmitter, at x=75 mm, x=125 mm etc. In addition, a reference face-to-face measurement is performed in order to identify the time delay in the measurement equipment. The recorded signal is shown in FIG. 3b. Furthermore, the time delay from the arrival time of the wave to the peak can be estimated. The total delay considered in this work is Δₜ=25.76 μs.

### Signal Processing

The captured signals and corresponding transducer locations are imported on a workstation with MATLAB for further processing. It should be noted that due to the large amount of conducted measurements, the data is down-sampled to a sampling frequency of 5 MHz in order to minimize the required memory.

The algorithm developed in this work is based on the envelope function of the recorded signal similar to the algorithm used by Schaal et al. [22]. To this end, the Hilbert transform is used to calculate the analytic signal. When the absolute value of the analytic signal is taken, the envelope function is derived. Once the envelope functions are determined, a threshold is manually defined for each run. Next, a local maximum search is implemented for each segment of values above the threshold. Through this procedure, the individual wave peaks are identified. Using the principle of time-of-flight, the wave path lengths d are determined from the peak times tₚ. To this end, the group velocities are determined for an assumed material properties and plate thickness, leading to a group velocity c_{g} of the A₀ wave of 2865 m/s. Considering the delay of the equipment as well as the delay between the beginning and the peak of the wave, the path lengths can be calculated via:

d=c_{g}(tₚ−Δₜ)

It should be noted that the group velocity could be estimated based on an inverse path evaluation, thus completely removing any necessary baseline information.

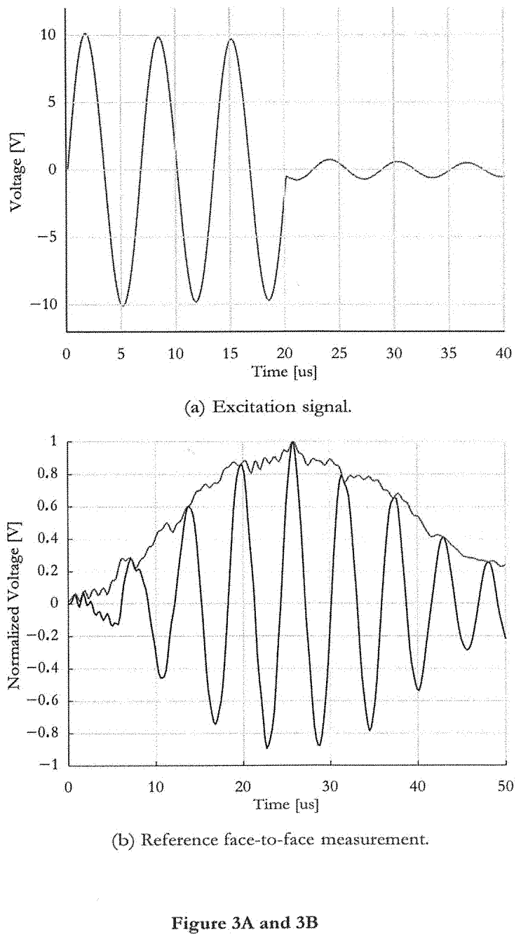

For edge detection, the second peak in each wave signal and their corresponding wave path lengths are evaluated. This wave path is translated into four possible locations of reflections using triangulation (see FIG. 4a):
1) the wave propagates to the left of the transmitter and is reflected back to the receiver,
2) the wave propagates to the right and is reflected to the receiver,
3) the wave travels “above” the transducers and is reflected back to the receiver, and
4) the wave travels “below” the transducers and is reflected to the receiver.

Since the used receiver is assumed to be axially symmetric, the incident angle of the reflected wave cannot be determined, and all four possible locations are evaluated. When all the measurements are processed, the resulting plot will show a map of possible edge locations. Since it is not possible for edges to be located in the area where the transducers have been placed, the area of transducer locations is eliminated from the analysis.

With regards to the stiffener detection, the distance calculated from the first peak in the captured signal is considered. Any stiffener will increase the thickness of the base plate. This increase in thickness will lead to a change in group velocity if strong bonding is assumed. Thus, based on the dispersion characteristics of the fundamental A₀ at low frequencies, a significant change in group velocity is expected. For example, if the thickness is assumed to be doubled, the corresponding group velocity is 3130 m/s (9% difference). Hence the peak should arrive earlier, and since the wave path length is evaluated based on the original group velocity estimate, the estimated distance would be shorter than those from non-stiffened regions. Hence, all estimated wave path lengths d based on the first peak time are sorted in ascending order, and only a subset of the lowest lengths is used to locate the stiffened region. In FIG. 4b, the general process is depicted.

### Results

The proposed methods are applied to the stiffened aluminum plate, as described herein. In total, 342 measurements are conducted, and the corresponding signals are recorded. First, the edge detection algorithm is applied, and the results are described herein. Then, the location of the stiffener is estimated.

### Edge Detection

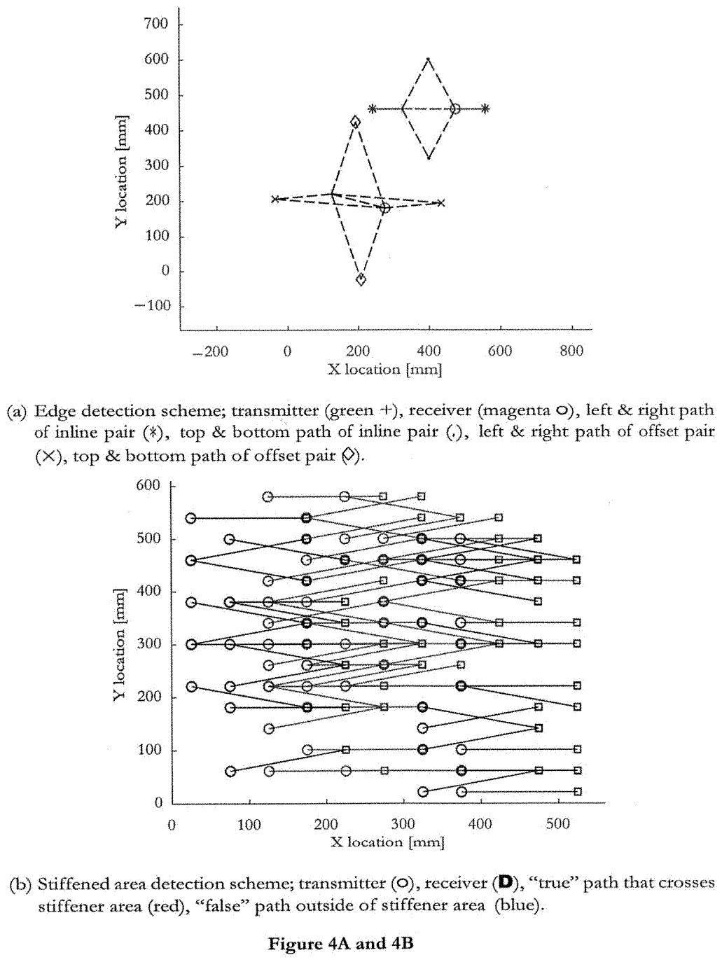

In FIG. 5, typical signals used for the edge detection are depicted. In FIG. 5a, the transmitter and receiver are on a line parallel to the coordinate axes, while in FIG. 5b, the transmitter and receiver are on an arbitrarily angled line. In addition to the raw signals, the determined envelopes are shown as well as the defined thresholds and the identified peaks.

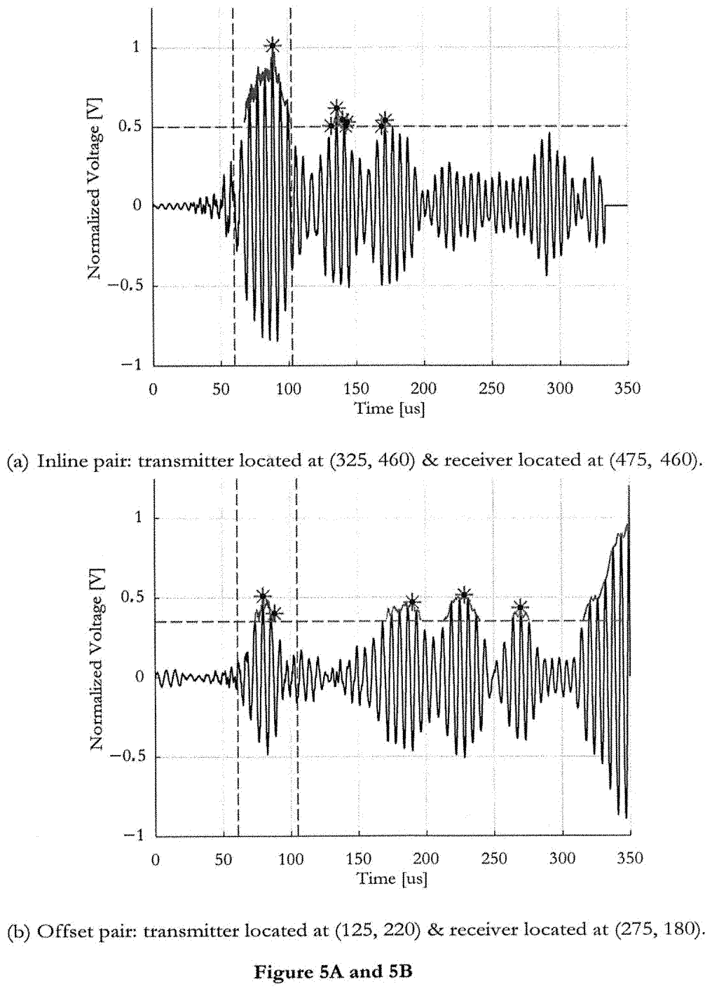

Based on the path lengths calculated from the second peaks, an edge reflection likelihood map is generated, as shown in FIG. 6. The transducers that are a certain distance from the edge of the plate are used to demonstrate that the transducers do not necessarily have to be located near the edges to detect them. The area in which transducers have been located is shaded in yellow (in the middle square), and the possible reflections from within this area can safely be ignored in determining the edges of the plate. Three scenarios are examined with a minimum distance from the edges of 25 mm, 50 mm, and 100 mm, respectively. However, there is significant noise in all directions, and the resulting map of possible edge reflection locations is not conclusive to determining the edges of the plate.

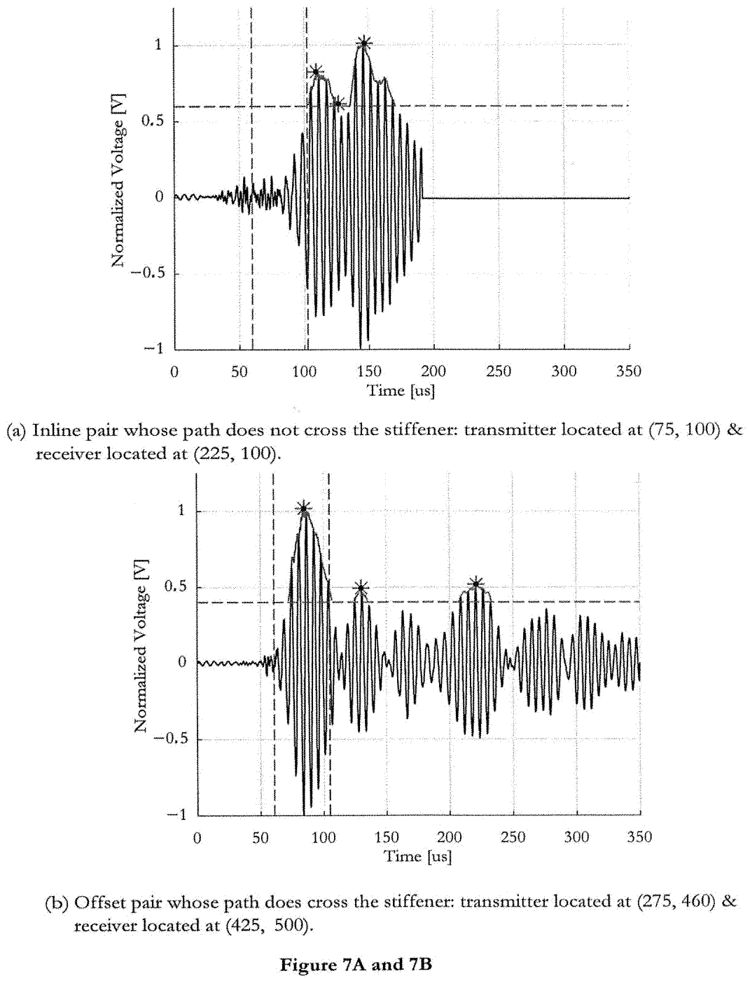

For edge detection, the second peak in each wave signal and their corresponding wave path lengths are evaluated. However, the exact origin of the edge reflection is unknown because the data is nondirectional. Hence, this wave path is translated into four possible locations of reflections using triangulation (see FIG. 8(a)) the wave propagates to the left of the transmitter and is reflected back to the receiver, 2) the wave propagates to the right and is reflected to the receiver, 3) the wave travels “above” the transducers and is reflected back to the receiver, and 4) the wave travels “below” the transducers and is reflected to the receiver. Since the receiver used is assumed to be axially symmetric, the incident angle of the reflected wave cannot be determined, and all four possible locations are evaluated. It is not possible for edges to be located in the area where the transducers have been placed since the transducers must make full contact with the specimen. Thus, the area of transducer locations is eliminated from the analysis.

### Detection of Stiffened Region

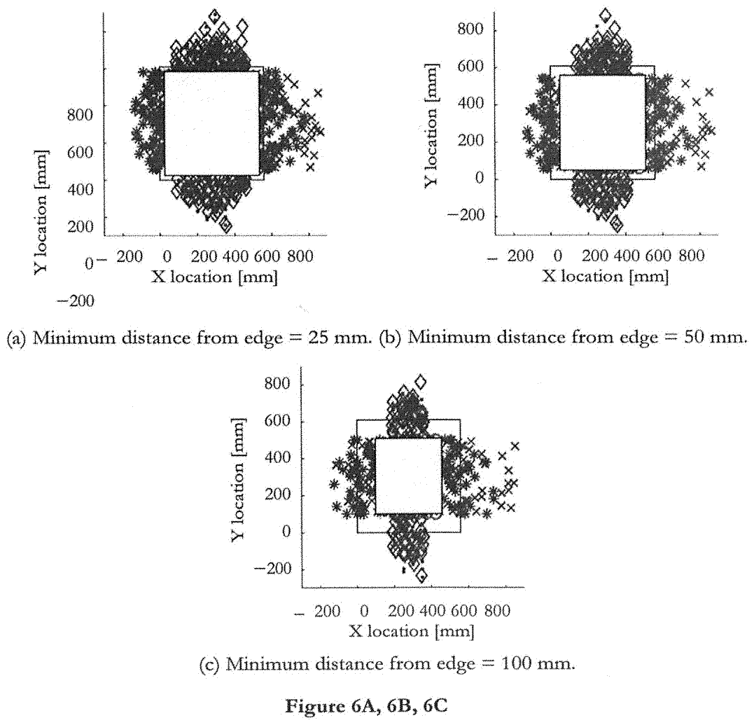

In FIG. 7, two example signals are shown that depict the differences in the signals that are used to estimate the location of the stiffener. It can be seen that the arrival time of the first peak is earlier in FIG. 7b even though the distance between this (offset) transmitter-receiver pair is larger than for the (inline) pair in FIG. 7a. This inherent change in velocity can be attributed to the fact that the transmitter-receiver pair in FIG. 7b is located across the stiffened region.

In FIG. 8, the results of the algorithm to reverse engineer the location of the stiffener are summarized, in which 75 pairs of the “shortest” distances are considered and plotted. It can be seen that some of the evaluated pairs are outside of the region of the stiffener. However, the ratio of correctly identified paths vs. incorrect paths is 1.14, i.e. paths in the stiffened region seem to have at least on average a slightly earlier arrival time. By using this method, it is possible to determine a likelihood map for the stiffener, but the exact location of the stiffener cannot be determined.

In this work, 342 pitch-catch Lamb wave measurements on a stiffened aluminum plate have been conducted, and an automatic peak detection algorithm based on the Hilbert transform has been applied.

For edge detection, the distance calculated from the second peak from the captured wave signals is used to determine the possible paths of reflected waves, leading to four possible edge locations for each transmitter- receiver pair. A map is generated of the possible reflection locations. While the area in which transducers are placed can be eliminated from the analysis, the remaining points should have indicated likely edges of the plate. However, the data was inconclusive because of the excessive noise. Had there been a more distinct pattern, a computer vision algorithm would have been implemented to fit a line in the possible reflection points to determine the edges.

As for stiffener detection, the distance calculated from the first peak is used to determine the direct path between the transmitter and receiver. The A₀ group velocity for the stiffened area is higher than that for the regular plate. If the stiffener exists in any part of the direct path, the arrival time is earlier than the expected arrival time. When the pairs of the 75 “shortest” measurements are plotted, the map shows a likely area of the stiffener, with a 1.14:1 true to false ratio. However, it does not show the exact location of the stiffener.

Although the experiment and analysis are somewhat able to reverse engineer the structure without establishing any baseline measurements, several assumptions are made for the scope of this work. First, the coordinate system and grid are drawn parallel to the edges of the plate. Further, knowledge of group velocities is assumed for the time-of-flight calculations. In future work, a focus could be to determine the group velocities directly from measurements on the specimen. In order to enhance the localization of the stiffener, it is possible to consider the reflections from the stiffener. Despite these assumptions, this work provides a step closer to detecting damages in an unknown structure and locating the defects on the map generated by guided wave-based NDT methods.

### ROBOT PLATFORM

In this Example, the work relevant to the development of the NDT robot platform is discussed. First, a mobile robot is designed; development and the components are described. Because it needs to move autonomously, the path planning algorithm is developed, programmed, and tested on a robot platform in addition to developing an algorithm to navigate the transmitter. The results of the path planning algorithms are presented herein. An NDT module is developed to be implemented on the robot platform with a proof-of-concept demonstration provided.

### Design and Development of Robot

The design parameters for the robot include size, types of sensors for indoor navigation and cliff detection, and remotely-controlled and autonomous drive modes. Additionally, the NDT module is to be mounted onto the chassis.

The envelope dimensions of the robot are 6 in by 6 in by 6 in. The chassis is designed to be in the approximate shape of a cube with various levels or shelves to hold the electronic components. It has a differential drive system, in which two motors drive the left and right wheels, and a single caster wheel is included for stability. The differential drive system is ideal because it allows for the robot to turn in place about the center of its wheelbase. Micro metal gearmotors (Pololu 3080) are selected for their size to fit into the small footprint of the envelope dimensions. They also have encoders (12 counts per revolution, Pololu 3081) to provide feedback in estimating how far the robot has traveled. Pre-preg fiberglass is laid up and painted to make the side panels. The composite was chosen for its lightweight quality and stiffness. Because various sensors need to extend beyond the exterior walls, fiberglass is easily able to be machined using a laser cutter to make the necessary mounting holes.

Since the eventual goal is to implement a robot to perform NDT autonomously on airplane wings, it is assumed maintenance and NDT will occur indoors, so GPS will not be a viable sensor system. Therefore, an indoor navigation system is utilized. The Marvelmind system consists of ultrasonic beacons, which are mounted around the area of interest and of which one is placed on the robot as a mobile beacon, or “hedgehog.” The hedgehog is the transmitter, and the beacons are the receivers. A radio-frequency router is used to sync all beacons and is connected to a software interface, which is also called the dashboard. The dashboard is used to set the origin of the coordinate system as well as assigning the status of one of the beacons as the hedgehog.

In addition to the indoor navigation system, the robot requires a sensor for its heading. An inertial measurement unit (IMU, Pololu MinIMU-9 v5) is selected because it includes a gyroscope, accelerometer, and magnetometer. The magnetometer essentially serves as a compass and is used as feedback for robot motion, specifically for its yaw angle. While the first two sensors are not currently used in the robot platform, they may be applicable for more advanced terrains and structures.

Because the robot will eventually operate on a plate or similar structure for NDT, it needs to be able to detect the edges of the structure to prevent falling. For this purpose, infrared (IR, Sharp GP2Y0A41SK0F) sensors are tested to determine the minimum distance at which they could detect a cliff. Four of these are mounted onto the chassis: front left and right, and rear left and right, so that the robot has sufficient notice to avoid falling off an edge.

To tie the drivetrain and the sensors together, all the components are connected to an Arduino Mega microcontroller for the low-level control and sensor hub. A motor shield is used to control the two motors and stacked on top of the microcontroller board. The IR sensors and hedgehog are also connected to the Arduino through digital pins. A Raspberry Pi 3 is used as the microprocessor for the high-level control of the robot. The robot is able to be remotely controlled through a computer or a smart phone app, such that a user can input the desired target location for the robot to go straight or use the arrow-keys on the app to control the robot to turn and go straight.

Finally, an NDT module is designed. While much of this project focuses on using contact transducers, they are not a practical solution for a robot. Since contact transducers require a gel couplant as well as an actuator to make and ensure constant contact with the specimen, air-coupled transducers are selected instead. An air-coupled transducer is mounted to the chassis. An adapter is designed to hold the transducer using set screws, so the user can set the desired height from the surface of the specimen. The transducer is then mounted to a goniometric stage, or goniometer, to rotate the transducer to a desired angle. Then, another mount is used to attach the stage through the chassis' side panel and onto the frame. This module is used to conduct the NDT measurement either as a transmitter or a receiver. The circuitry necessary for the module includes an amplification and conditioning circuits.

### Path Planning Implementation

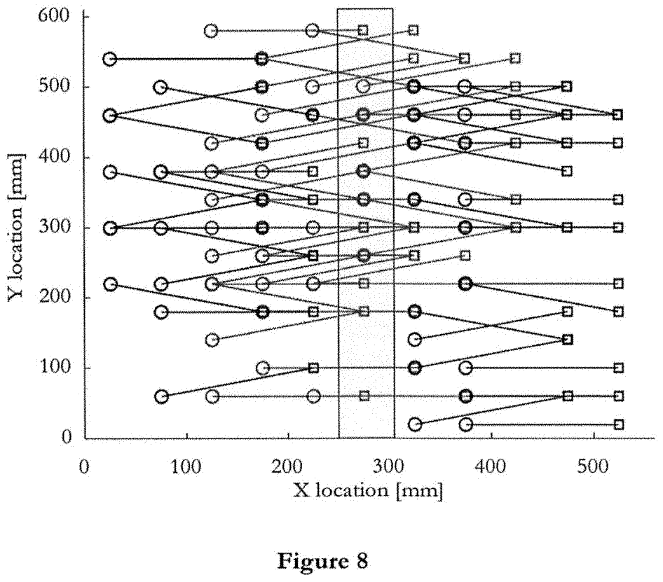

The overall goal is to input a single waypoint coordinate to the robot. In the NDT application, it is not necessary to include a queue of waypoints since the robot needs to go to the target location and take NDT measurements. Then, if the user wants another set of measurements, he or she can input another waypoint. The robot then calculates how much it needs to turn as well as how far to drive. The most straightforward method is to turn in place until the robot's heading is facing the target. Then, it moves forward until the desired location. With the magnetometer data and current position update from the indoor navigation, the robot uses the feedback to correct its motions along its path to the target. The overall logic for the path planning algorithm is shown in FIG. 9 which illustrates the three main states of the robot: straight, turning, and neutral.

iRobot Create 2 Platform

For the path planning algorithm, an iRobot Create 2 platform is used to test and implement the autonomous driving mode. It is selected because of its similarities to the robot that is designed, specifically that it uses a differential drive system and already includes IR cliff sensors. A Raspberry Pi 3 is added and used with ROS (Robot Operating System) for the high-level control.

To start, the Create 2 platform is used to implement basic commands to move forward and turn using odometry, which uses the motor encoder data. However, it is not practical to only use the odometry to control a robot because, without any feedback, there is a possibility of wheel slip or change in the terrain that can cause a shift in the robot's desired path. This can lead to the robot not approaching the correct final destination.

Next, the additional sensors are tested with the Create platform. Marvelmind supplies a ROS package, which is allows communication with mobile beacons and hedgehog, and provides location data received from them. Using the Marvelmind dashboard interface, the user is able to “freeze” and “unfreeze” the map to set their desired coordinate system based on the beacons. A specific beacon is selected to be the origin, and the software sets another beacon to be the other point to establish the x-axis. Additionally, the coordinate system can be rotated to match true north, which is the same frame as the compass readings. Since the robot will be driving on the surface, only the x and y positions are of interest.

In the turning-in-place code, the magnetometer on the IMU is used for heading feedback. The magnetometer is essentially a compass and uses the Earth's magnetic field. The motors on the robot are also considered because they affect the local magnetic field, a phenomenon which is called a hard-iron bias. Therefore, the IMU is mounted away from the chassis itself, specifically under the shelf on which the Raspberry Pi sits. Because of these factors affecting the magnetometer, it is necessary to calibrate the magnetometer before use. To do so, the robot is physically held and rotated such that all axes of the magnetometer are activated by the earth's magnetic field. In this manner, the bias from the motors can be removed from the readings of the magnetometer to better measure the earth's magnetic field.

Since the autonomous driving is ultimately tested on a table or similarly raised surface, it is possible for the robot to fall off the edge if a waypoint off of the table, if selected or the robot drives too close to the edge. As previously mentioned, the Create platform has four IR cliff sensors already installed: Left, Front Left, Front Right, and Right. The Create has an automatic cliff detection mode, but when it is being controlled by a different microprocessor, the default settings are overridden. Thus, for this work, when the IR sensors are triggered, the robot is programmed to stop in the autonomous driving mode.

### Coordinate Frames and Transformations

As in many robotic systems, multiple coordinate frames exist and must be transformed such that the robot can be programmed to move as expected. In this system, four frames exist. The Marvelmind beacons and dashboard are used to set the Global frame. The hedgehog is used to provide the position of the robot in the Global frame, and it is placed in the center of the robot where the red circle is shown. The iRobot Create platform has its own internal frame, shown in red, in which the x-axis is the forward direction of the robot and the y-axis points to the left of the robot. The compass provides an angle from north; θ is the complementary angle (from the x-axis to the blue arrow). Next, on the robot, there is a blue dashed arrow, which indicates the forward vector and driving direction of the robot. The purple circle shows the location of the transducer, and the purple Transducer frame is offset by a distance L from the center of the robot and the origin of its local frame. Finally, the green dotted arrow indicates the target vector from the robot, d is the distance from the robot center to the target, and a is the angle and direction the robot must turn to achieve the target vector. On the robot, the position vector of the robot is given by global coordinates provided by the hedgehog.

### Transducer Navigation for Transmitter and Receiver Modes

In the overall application, it is not the robot that is of interest to navigate. Rather, the objective is to navigate the air-coupled transducer to the location of the measurement either in transmitter or receiver mode. More details about air-coupled transducers will be discussed. In this work, assuming the forward direction of the robot is pointing in the y-axis, the transmitter is mounted along the x-axis at an offset of L=20 cm.

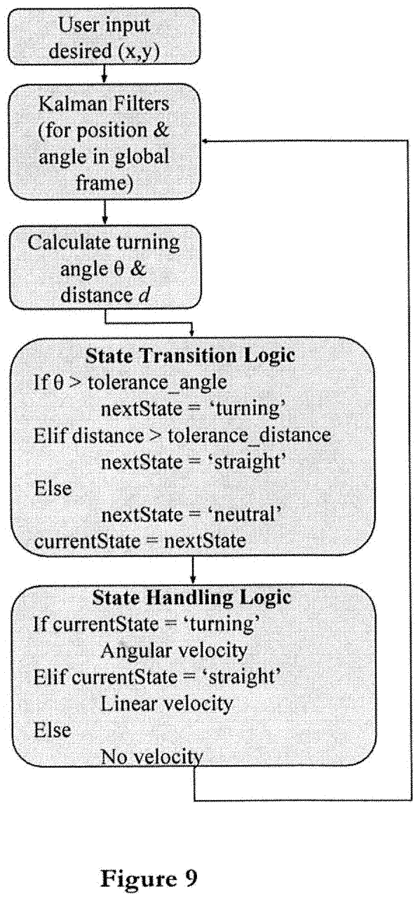

In transmitter mode, the robot travels from its initial starting position (Position 1 in FIG. 10a to the closest point on the dashed circle, which has its center at the target location and has a radius of L. Once the robot is in Position 2, the location of the red diamond is found by rotating the previous target vector by 90° counterclockwise. The robot rotates in place until the forward vector reaches the target location as shown in

FIG. 10b at which the transmitter is at the location of the original target, marked by the yellow diamond. In the case of the transmitter, the final orientation of the robot is not critical since the transmitted waves propagate in all directions.

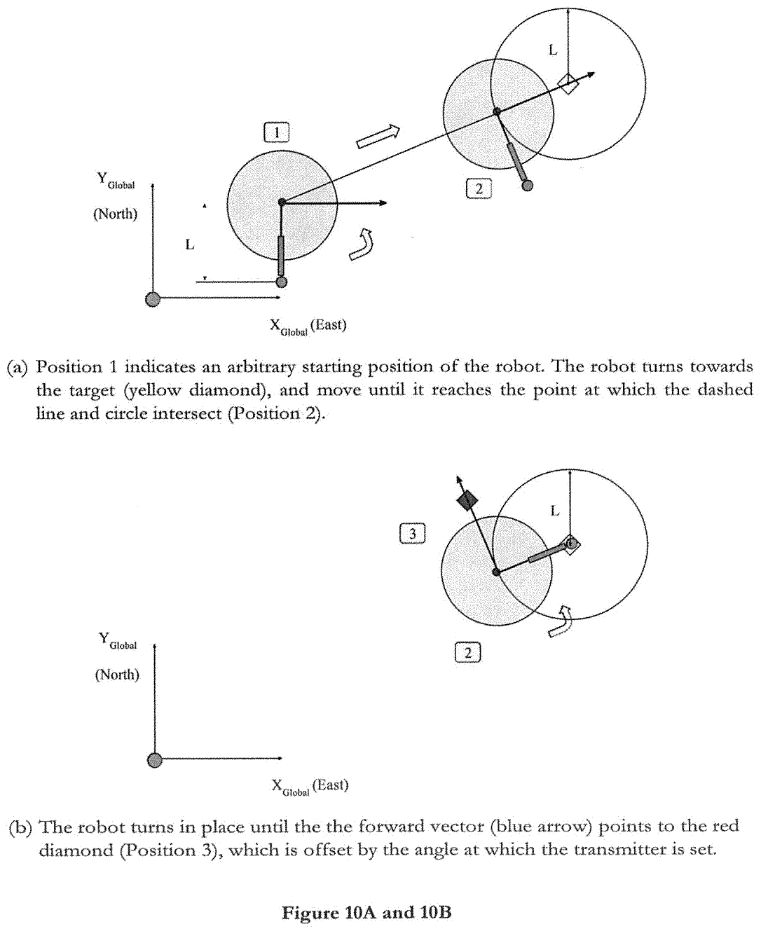

To illustrate the receiver mode, FIG. 11 shows a transmitter robot and a receiver robot, which is located close to the origin. In the case of receiver mode, the robot is given a measurement distance d as well as the direction of the transmitting robot, which is marked by the wave marker (although the transmitted waves propagate in all directions in the specimen). The red diamond is offset by L from the transmitter and indicates the effective target from which the receiver robot must travel d away and parallel to the transmitting robot's forward vector (Position 2 in FIG. 11a) Then, the robot rotates until its forward vector points to the red diamond, at which the receiver is in line with the transmitter (Position 3 in FIG. 11b). The receiver must be facing in the direction of the transmitter to detect the waves (which are indicated by the dashed arrow pointing from the transmitter).

### Kalman Filter

Despite including sensors for feedback, it is necessary to properly use the data to estimate the robot's position and heading. First, a Kalman filter (KF) is utilized to fuse the indoor navigation position data and the odometry. The overall steps of implementing a Kalman filter for this application are: to set the initial values, predict the state and error covariances, compute the Kalman gains, calculate the estimated position and heading, and finally compute the error covariances. [24]

To start, it is necessary to generate a mathematical model of the robot's kinematic behavior. [25] Since it is a differential drive robot, it can only travel in the forward (or backward) direction (the Create's local x-direction) and cannot move laterally (the Create's local y-direction). However, the Kalman filter considers the robot's movement in the global frame. Hence, the model reflects global movement. Assuming linear behavior in a discrete system, the system model of the robot can be described with the following linear equations:

$${[ \begin{matrix}x \\ y \\ \dot{x} \\ \dot{y}\end{matrix} ]}_{Current , Global} = [ \begin{matrix}1 & 0 & T & 0 \\ 0 & 1 & 0 & T \\ 0 & 0 & 1 & 0 \\ 0 & 0 & 0 & 1\end{matrix} ] [ \begin{matrix}{x}_{Robot , Global} \\ {y}_{Robot , Global} \\ {\dot{x}}_{Odometry} \\ {\dot{y}}_{Odometry}\end{matrix} ]$$

where A is the state transition matrix, and T is the loop rate of the robot. Next, the error (P) and measurement (H) covariance matrices are initialized as 4x4 identity matrices.

$$P = H = [ \begin{matrix}1 & 0 & 0 & 0 \\ 0 & 1 & 0 & 0 \\ 0 & 0 & 1 & 0 \\ 0 & 0 & 0 & 1\end{matrix} ]$$

Then, the process noise (Q) and sensor noise (R) covariance matrices are initialized.

The process noise covariance describes the variance of the actual system and can be modified to better describe the system. In this case, it is initialized with a small number along the diagonal:

$$Q = [ \begin{matrix}0.01 & 0 & 0 & 0 \\ 0 & 0.01 & 0 & 0 \\ 0 & 0 & 0.01 & 0 \\ 0 & 0 & 0 & 0.01\end{matrix} ]$$

The sensor noise covariance matrix is determined by calculating the variance of the sensors. The Marvelmind indoor navigation system supposedly has a ±2 cm accuracy of its position data. Assuming uniform distribution of the error, the variance can be evaluated (32) via:

$$V ( x ) = \frac{{( b - a )}^{2}}{12} ,$$

in which a is the lower end of the error and b is the upper end. Using the above equation, the variance of the indoor navigation is determined and initialized into the sensor noise covariance. Since the error of the odometry is unknown, the values for \dot{x} and \dot{y} are initialized as 1 m/s:

$$R = [ \begin{matrix}0.0133 & 0 & 0 & 0 \\ 0 & 0.0133 & 0 & 0 \\ 0 & 0 & 1 & 0 \\ 0 & 0 & 0 & 1\end{matrix} ]$$

Because this is a covariance matrix, the smaller values reflect a smaller covariance and, thus, more “trust” in the particular sensor. In this case, the filter “trusts” the indoor navigation sensors more than the odometry. However, R is used to determine the Kalman gains, which can vary with each loop and place more emphasis on one sensor versus the other.

Finally, the measurements of the position and velocity will be saved to z, which is the measurement vector. The position will be updated by the x and y location data from the indoor navigation system, which is considered to be the Global frame. The odometry from the Create provides velocity data; however, the velocities are in the robot's local frame. The state transition matrix describes the robot's behavior with respect to the global frame, so the velocities must also be described within the global frame. The norm of the odometry velocity is calculated as the speed, which is multiplied by the robot's forward vector to obtain the velocity in the global frame.

The following describes the KF process as instructed by Kim. [24] The hat (^) notation indicates an estimated value, and the superscript “-” indicates a predicted value. The KF begins with setting the initial values:

$${\hat{x}}_{0} = [ \begin{matrix}{x}_{Robot , Global} \\ {y}_{Robot , Global} \\ {\dot{x}}_{Odometry , Global} \\ {\dot{y}}_{Odometry , Global}\end{matrix} ]$$

Next, the prediction stage consists of predicting the state (x) and error (P) covariance matrices:

\hat{x}ₖ⁻=A\hat{x}ₖ₋₁⁻

Pₖ⁻=APₖ⁻A^{T}+Q

Then, the Kalman gains are computed in a 4×4 matrix:

Kₖ=Pₖ⁻H_{T}(HPₖ⁻H^{t}+R)⁻¹

After the gains are calculated, the measurements from the sensors are introduced, and the estimation stage is given by:

\hat{x}ₖ=\hat{x}ₖ⁻+Kₖ(zₖ−H\hat{x}ₖ⁻)

The error covariance (P) is calculated again to prepare for the next iteration:

Pₖ=Pₖ⁻−KₖHPₖ⁻

Finally, the process repeats through the last 5 equations until the function, in which the KF is embedded, is terminated.

Similarly, a KF is developed for the heading estimate. In this case, the compass readings from the IMU are fused with the angular velocity from the robot's odometry.

The compass provides the heading in degrees from North, and the angular velocity is in radians per second. To reconcile these units, the degrees are converted into radians for all calculations in the KF.

$$[ \begin{matrix}Θ \\ \dot{Θ}\end{matrix} ] = [ \begin{matrix}1 & T \\ 0 & 1\end{matrix} ] [ \begin{matrix}{Θ}_{Compass} \\ {\dot{Θ}}_{Odometry}\end{matrix} ]$$

where A and Tare again the state transition matrix and loop rate, respectively. Similarly, the error (P) and measurement (H) covariance matrices are initialized as 2×2 identity matrices. The process covariance matrix (Q) is initialized with a small value along the diagonal and sensor noise matrix (R) is initialized with 2° (or 0.0349 rad) for the heading error and 1 rad/s for the angular velocity. Similarly, the sensor noise matrix is set such that the odometry is trusted less than the compass.

$$P = H = [ \begin{matrix}1 & 0 \\ 0 & 1\end{matrix} ]$$

$$Q = [ \begin{matrix}0.01 & 0 \\ 0 & 0.01\end{matrix} ]$$

$$R = [ \begin{matrix}0.0349 & 0 \\ 0 & 1\end{matrix} ]$$

Next, the initial heading is set by the compass reading, which is converted into radians, and the angular velocity from the Create:

$$\text{?}$$

$$\text{?} \text{indicates text missing or illegible when filed}$$

The angular KF follows the same process as the positional KF by inserting the state from this equation into the loop starting from this equation above:

### Path Planning

The functions for autonomous drive are developed and tested on the Create platform. The robot is successfully able to go straight for a user-input distance using odometry. The user is also able to input an angle for the robot to turn left or right, and similarly, using odometry, the robot is able to turn the desired angle. In an open-loop program, the two functions are simply put together, such that the user can input a queue of desired distances and angles for the robot to travel.

In the next step, the transducer in transmitting mode is tested. The driving function of navigating the robot chassis serves as a base, and additional functions are programmed to determine the new target point and to turn in place until the transducer is in the correct location.

### Robot Navigation

With the integration of the Marvelmind indoor navigation system as well as the Kalman filter (KF), the system now becomes closed-loop, thus providing feedback to the robot. First, the driving function is tested without the KF and only relies on the hedgehog for the robot's position. Then, the KF is used, for which, the KF provides an estimate of the robot's position rather than solely relying on the hedgehog's position data. The driving algorithms are tested on a table with the beacons set up in the corners. Then, the desired (x,y) coordinates are input.

As seen in the path planning flow chart (see FIG. 29) the robot essentially turns until it reaches the angle error zone and proceeds to move forward. In every loop, the respective Kalman filters provide a position and angle estimate, by which the errors are calculated. In the test setup, the target waypoint is set for x=0.5 m and y=0.25 m in the global (Marvelmind) frame. The robot is set in random starting positions and orientations for ten cases: combinations of the starting pose being “near” the target (up to 0.3 m), “mid” which is farther from the target (from 0.31-0.4 m), and “far” from the target (beyond 0.41 m) as well as facing towards the target (0°-30°, facing to the side of the target (31°-90°, and facing away from the target (beyond 90°) (see Table 1)

TABLE 1
Ten random starting poses of the robot to test robustness of path
planning algorithm with and without the Kalman Filter (KF).

Starting Pose

| | No KF | KF |
|---|---|---|
| Run 1 | Far, Toward | Mid, Side |
| Run 2 | Far, Away | Mid, Away |
| Run 3 | Near, Toward | Mid, Side |
| Run 4 | Mid, Side | Mid, Away |
| Run 5 | Near, Side | Near, Toward |
| Run 6 | Mid, Toward | Far, Toward |
| Run 7 | Mid, Away | Near, Away |
| Run 8 | Near, Away | Near, Side |
| Run 9 | Mid, Side | Far, Toward |
| Run 10 | Far, Away | Near, Side |

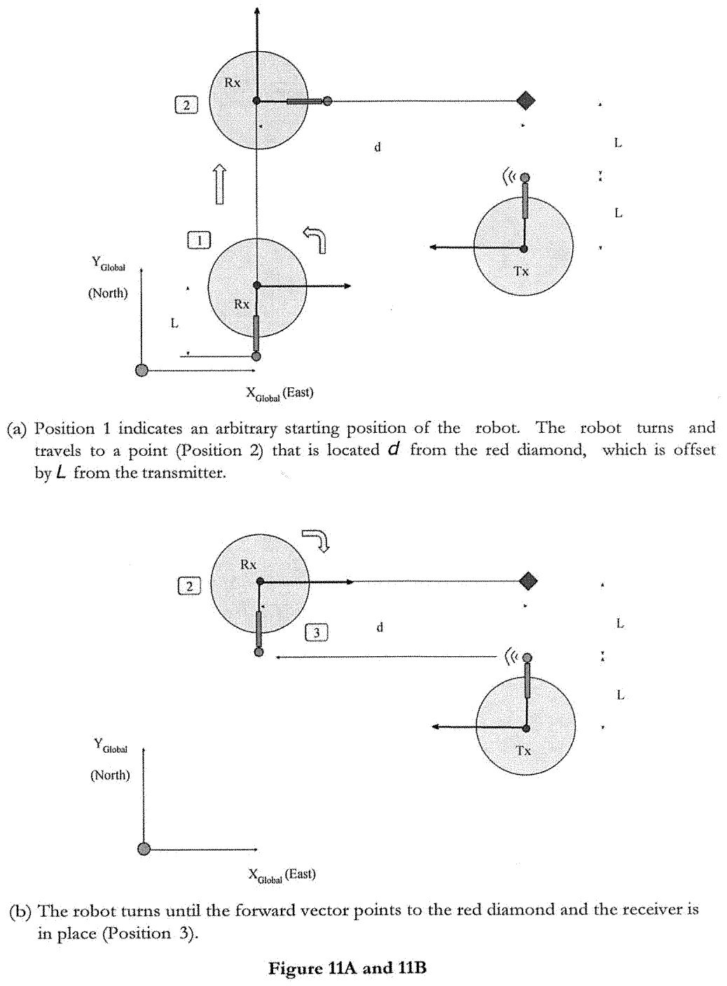

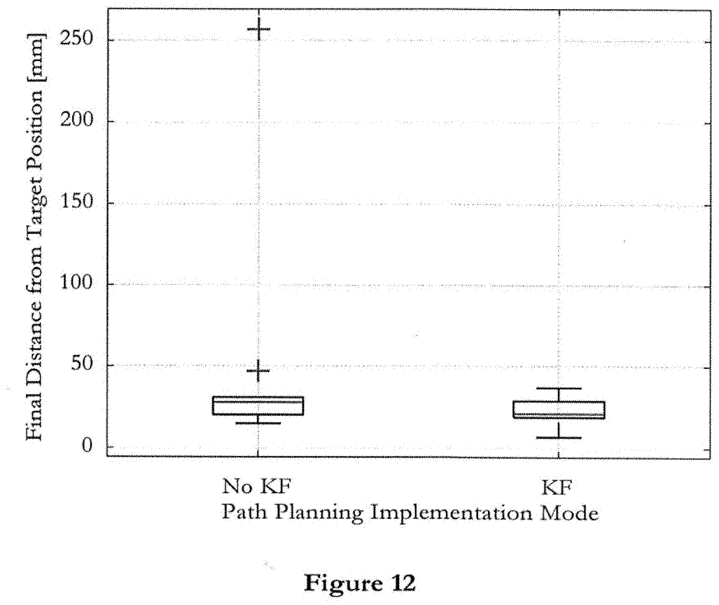

The robot is tested with and without the Kalman Filter. After ten test cases for each scenario, the results can be seen in the box plot (see FIG. 12) and Table 2. Without the KF, the mean final position error is 49.8 mm while using the KF, the mean final distance is 22.8 mm. As previously mentioned, the distance tolerance is set at 0.03 m. Since the accuracy of the Marvelmind indoor navigation system is supposedly ±2 cm, the KF result fits within the expectation. Telemetry from one of the KF cases is plotted in FIG. 13. It is important to note that the position of the robot is actually the position of the hedgehog on the robot, which is set at the center of the Create. The plot on the left shows the final location of the robot, where green is the Kalman filtered position and the red × is the target waypoint. The blue arrow indicates the forward direction of the robot. Finally, the blue dots are the fixed beacons on the corners of the table. On the right side, there are two plots to depict the error for distance to target (top) and error for angle to target (bottom). For the distance error, a dead-zone band is set for 0.03 m, and it can be seen that the error converges. The angle error is set at 3°. In the bottom right plot, the angle can be seen to converge at 0°; however, toward the end of the run, the heading jumps to 100°. This can be explained by the robot and its forward vector passing the target, so it would need to turn around to point at the target, thus minimizing the angle error. However, in this algorithm, only the distance is of interest, rather than its final heading.

TABLE 2
Performance metrics of positional Kalman filter for robot's
position (in mm) using the Marvelmind indoor navigation and
Create's odometry. Error metric is based on distance from
robot's final position to target (for 10 cases each).

| | No KF | KF |
|---|---|---|
| Mean | 49.8 | 22.8 |
| Minimum | 15 | 7 |
| Maximum | 257 | 37 |
| Median | 28 | 21.3 |

Finally, the IR cliff sensors are programmed and tested. When there is no cliff, the sensor has a value of 0, and when there is a cliff, the value will change to 1. When any of the sensors detect an edge, the entire state will be 1. This logic will be integrated into the robot such that when the robot encounters an edge, it will stop its travel. The Create is tested on a table and is given a waypoint that is beyond the table's surface. The robot is successfully able to stop when it detects the edge.

### Transmitter Mode Navigation

Earlier, the algorithms for transmitter and receiver modes are discussed but only the transmitter mode is implemented and discussed here.

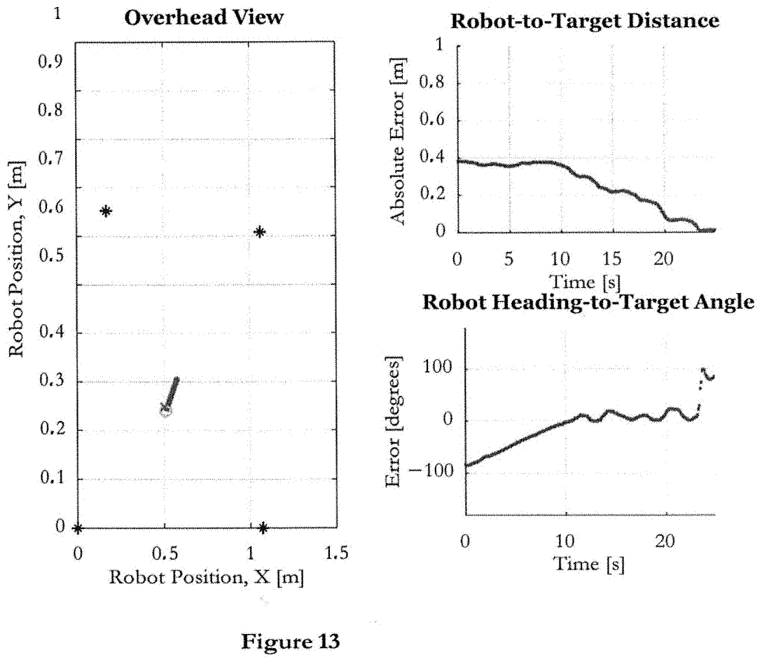

To navigate the transmitter, the algorithm consists of three main functions: 1) evaluating and 2) driving to the effective target, and 3) turning in place until the transducer is in the correct location. In this case, the angular KF is tested separately to verify its effectiveness by setting the robot on the circle that had a radius of L from the target location of the transducer. Then, the robot is programmed to turn in place for a random amount of seconds, which serves as the starting orientation. Finally, the angular KF fuses the compass readings as well the angular velocity from odometry to command the robot to turn to its target. Since the transmission mode does not require a specific orientation of the transducer, only the final position error will be considered. The box plot in FIG. 14 and Table 3 show the results of the ten cases with and without the angular KF. It is important to note that the mean value of the position errors is subtracted from the data to remove the bias; in each of the cases, the robot turns to an area that is offset from the actual target. Despite compass calibration, the robot's final position is not significantly improved.

TABLE 3
Performance metrics of angular Kalman filter for robot's position
(in mm) using the Marvelmind indoor navigation and Create's
odometry. Since the transmission mode does not require a specific
heading of the transducer, the robot's final position error
is considered. Since there is a constant bias, the mean is subtracted
from the data. The error metric is based on distance from robot's
final position to target (for 10 cases each).

| | No KF | KF |
|---|---|---|
| Minimum | −7.4 | −8.15 |
| Maximum | 7.6 | 6.85 |
| Median | 0.6 | 0.1 |

After the angular KF has been verified, the transmission mode driving algorithm is tested. The robot is set in random starting position for ten cases as seen in Table 4.

TABLE 4
Ten random starting poses of the robot to test robustness of
path planning algorithm with both positional and angular Kalman
Filters for the robot driving in transmission mode.

| | Starting Pose |
|---|---|
| Run 1 | Mid, Toward |
| Run 2 | Near, Side |
| Run 3 | Mid, Away |
| Run 4 | Mid, Toward |
| Run 5 | Near, Away |
| Run 6 | Far, Toward |
| Run 7 | Near, Toward |
| Run 8 | Far, Away |
| Run 9 | Near, Side |
| Run 10 | Mid, Side |

In all of these cases, the KFs are used, and the results show the final position error (see Table 5. There's is a significant difference between the minimum and maximum errors. As previously mentioned, there is a constant bias despite the compass calibration; additionally, the angular KF test is conducted from one location (with random starting orientations). In these ten cases, the robot starts from random locations, so its final orientations cause the final position error to increase if the final orientation is not what is desired. With a more robust sensor, the orientation could be improved, thus improving the final position error.

TABLE 5
Performance metrics of angular Kalman filter for robot's
position (in mm) using the Marvelmind indoor navigation and
Create's odometry. The error metric is based on distance
from robot's final position to target (for 10 cases each).

| | |
|---|---|
| Mean | 58.9 |
| Minimum | 16 |
| Maximum | 103 |
| Median | 77 |

### NDT Module

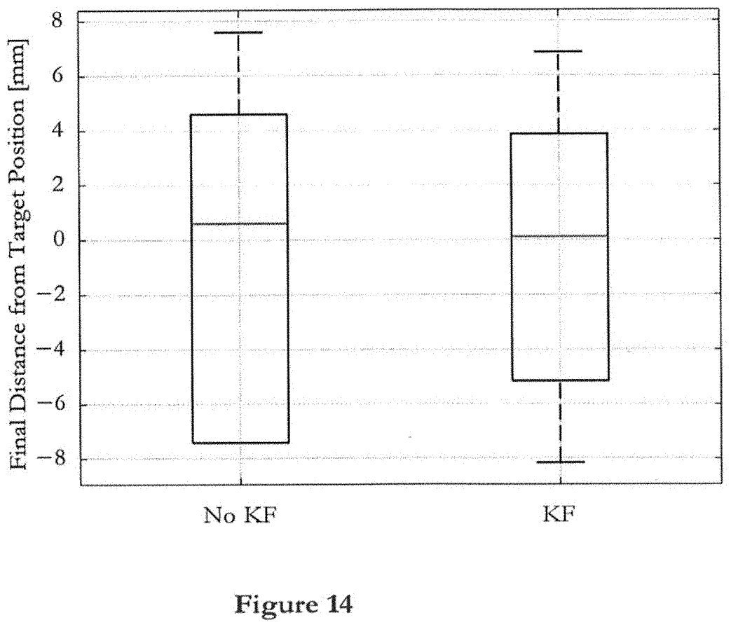

Since the eventual goal of this robot is to conduct NDT measurements autonomously, a module to mount onto the robot is developed. In addition to the air-coupled transducer, goniometer, and mounts, there are a signal amplification circuit, signal conditioning circuit, a microcontroller, and batteries. Both circuits are included because this allows the flexibility to switch the robot between transmitting and receiving modes and possibly operate in pulse-echo, which is when one transducer transmits a wave burst and immediately switches to receiving mode to record the data. The NDT measurements are still conducted in pitch-catch, so there is another transducer to act in the other mode. The circuits are based on the research presented by Pertsch et al. [29], and the schematics for the circuits developed for this robot are shown in FIG. 15.

### Air-Coupled Transducers

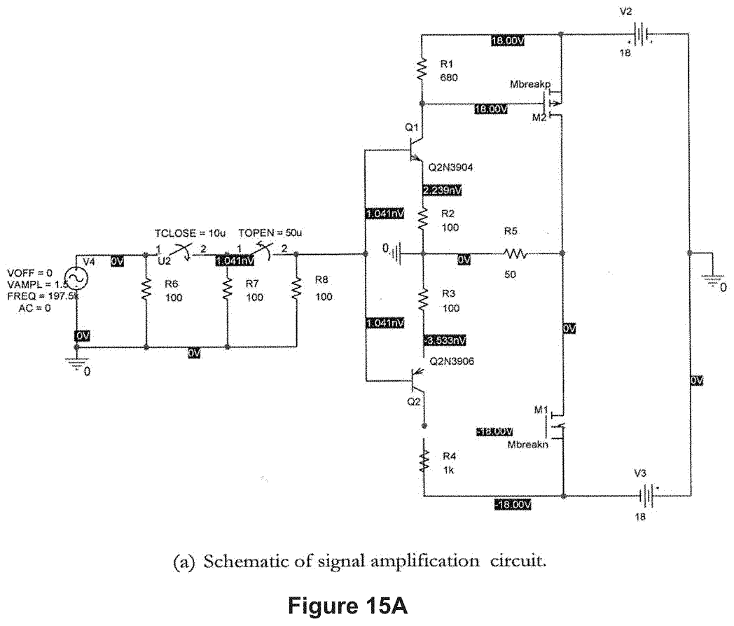

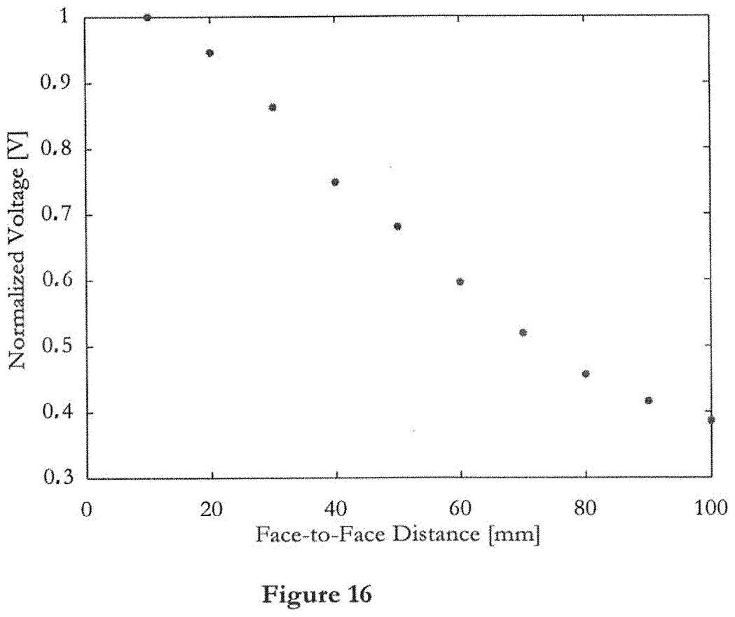

The air-coupled transducer experiment is depicted in FIG. 18. A pair of Sonotec CF 200 transducers is used and excited at f=200 kHz with a similar 3-cycle sinusoidal tone burst. To test the sensitivity to alignment, a pair of transducers are tested, such that one is transmitting a signal through air and the other is receiving. They are laid aligned face-to-face at various distances (see FIG. 16) as well as fixed distances and the receiver rotated about the fixed location. This experiment is also used to verify the theoretical value of speed of sound in air (343 m/s).

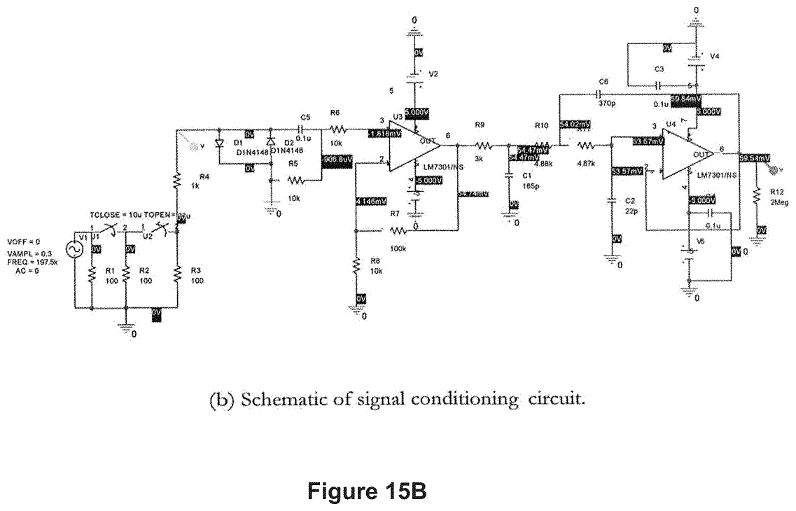

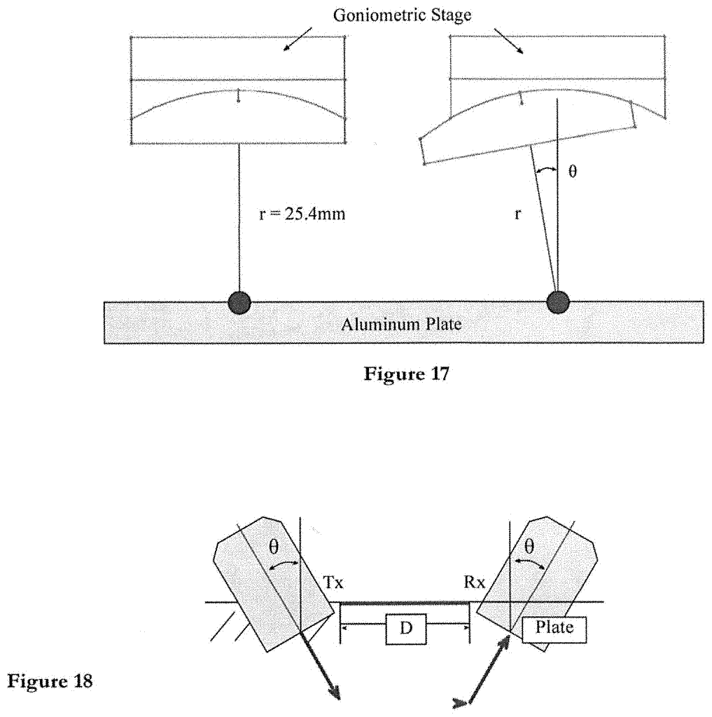

As expected, the larger the distances between the pair, the lower the amplitude, and the rotation also causes a significant decrease of amplitude. This initial test shows that the transducers are sensitive to varying angles. By using a goniometer (Thorlabs GN1/M), the transducer can be rotated about a point that is 25.4 mm from the surface of the goniometer (see FIG. 17) The goniometer is set by manually using a micrometer and has a range of ±10° with incremental markings of 0.167°. Special stands are designed to mount the goniometer and transmitter as well as a separate stand for the receiver. The ideal angle of transmission can be calculated using Snell's Law [19] via:

$$\frac{sin ( {Θ}_{1} )}{sin ( {Θ}_{2} )} = \frac{{c}_{1}}{{c}_{2}} ,$$

where c is the phase velocity, and Θ is the angle measured from the vertical. An illustration of the above equation can be seen in FIG. 19. In the case of an aluminum plate, the first medium is air, for which c₁=343 m/s, and the second medium is aluminum, for which c₂=2021 m/s, which is the A₀ velocity at 200 kHz and derived from the dispersion curves. The desired Θ₁ is calculated by setting Θ₂=90° since the Lamb wave should travel along the plate. With this information, an experiment is conducted to verify that the strongest signal can be recorded when the signal is transmitted at the calculated angle of Θ₁=9.77°. The transducer is tested to confirm the angle; however, after sweeping through angles using the goniometer, the transducer seemed to produce best results when angled at 8.5°, and this angle is used for all experiments. The slight offset could be due to small misalignments in the mounts.

It can also be seen that the S₀ has a higher phase velocity at f=200 kHz, for which the calculated Θ₁ is 3.70°. Because of the significant difference in angle between the A₀ and S₀ modes, it is important to note that it is possible only to excite one of the modes and not the other. This is due to the fact that the experiment is conducted using air-coupled transducers. If contact transducers are used as in the experiment with the stiffened plate, both modes are inevitably excited.

### NDT Module Circuitry

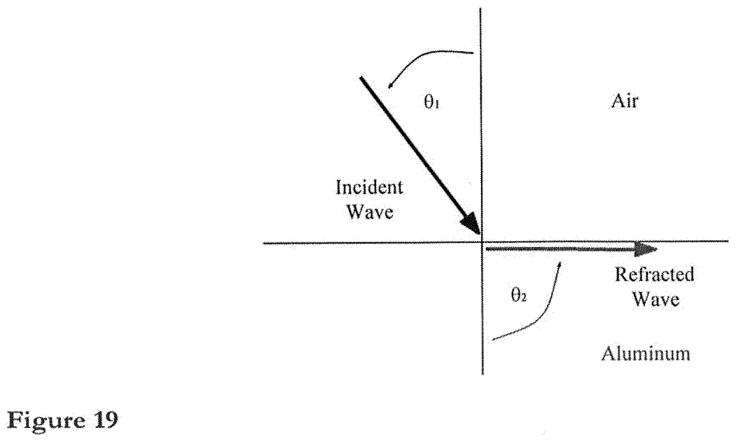

While the NDT circuits have been developed and tested, a separate set up is used for the NDT module proof-of-concept. The block diagram of the proposed set up is shown in FIG. 20. For the benchtop instrumentation, a waveform function generator (Keysight 33412B) and oscilloscope (Rigol DS1054Z) are used.

For transmission, the STEVAL-IME013V1 board is selected because it is designed for medical ultrasonic imaging applications. While it is able to control up to eight transducers, for the purpose of this project, only one contact transducer is connected and controlled. Arbitrary signals can be uploaded to the board, so a three-cycle wave burst at f=150 kHz is set. The board is driven by 15 V and it is split into low voltage and high voltage blocks, in which ±5 V and ±12 V regulators are connected, respectively. The low voltage block powers the board. When the signal is generated, the high voltage block is also powered. For the benchtop experiment, a power supply is used, but for the application on the robot, a battery pack is used for the sake of mobility.

For the receiving mode, a circuit board based on the signal conditioning circuit by Pertsch et al. [29] is manufactured into a printed circuit board. The filtered signal is passed to a microcontroller (CY8CKIT-046 PSoC), which has a 12-bit SAR ADC (analog-to-digital converter). Furthermore, this board is selected because the ADC is capable of sampling at 1 MHz.

To simulate the NDT experiment on the embedded implementation, the transmission and receiver circuits are connected, such that the signal can be triggered the microcontroller on the receiver. In this manner, the transmission board excites the signal through the amplification circuit and transducer. The wave signal is received by the other transducer, and the signal passes through the conditioning circuit to be recorded.

### NDT Module Proof-of-Concept

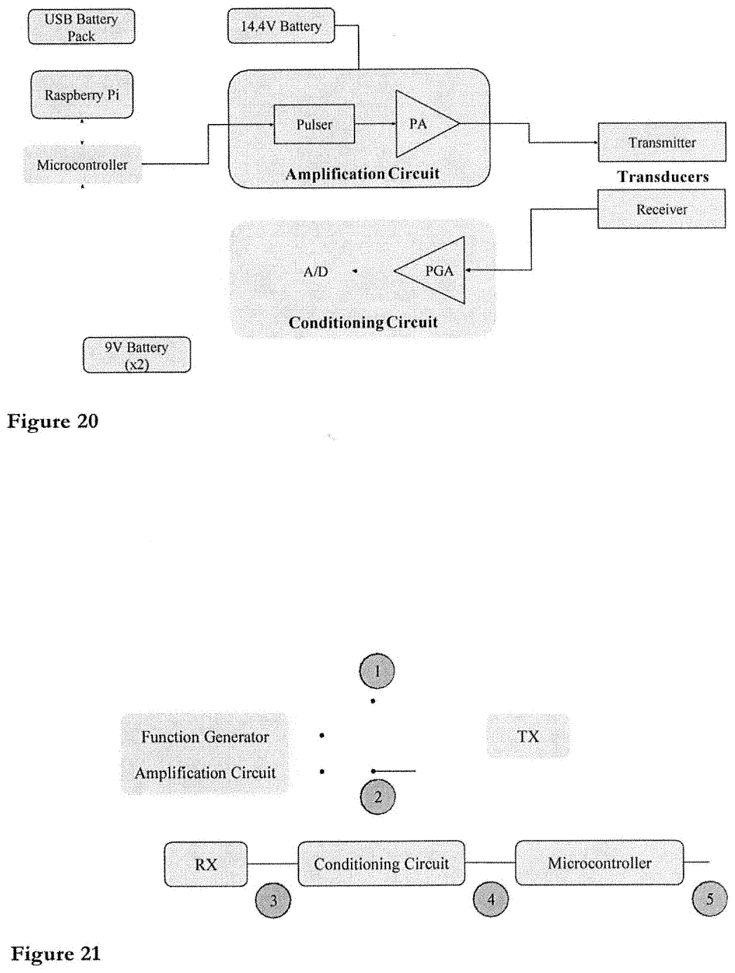

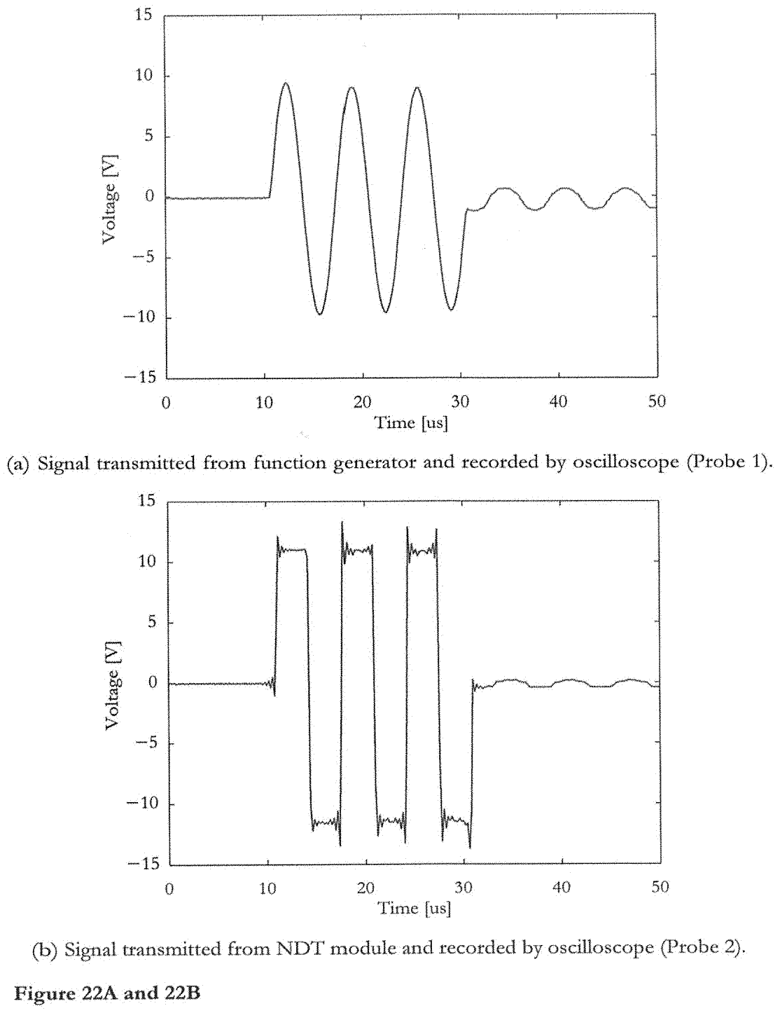

With the NDT module's circuitry, experiments are conducted on the unstiffened aluminum plate. The transmitter is mounted to the goniometer, which is set at 8.5° (as previously determined), facing toward the receiver. The face of the transmitter is 21 mm from the plate. The receiver is mounted to a bracket and facing straight down with its face 22 mm from the plate. Five scenarios are tested for comparison:
1) transmitter is connected to the function generator and receiver is connected to the oscilloscope,
2) the transmitter is connected to the amplification circuit and receiver is connected to the oscilloscope,
3) transmitter is connected to the amplification circuit, the receiver is connected to the conditioning circuit, and oscilloscope is connected post-conditioning,
4) the transmitter is connected to the function generator and the receiver is connected to the conditioning circuit, and oscilloscope is connected post- conditioning; and
5) the results from case 3 is buffered into the internal RAM of the microcontroller and fetched by the laptop via USB to simulate the data saving onto the robot. The diagram in FIG. 21 shows the locations in the system where the signals are captured.
   First, the transmitted signals (probes 1 and 2 from FIG. 21 are shown in FIG. 22 for signals generated by the benchtop function generator and the amplification circuit, respectively. In both plots, the signals begin at 10 μs since they were recorded at different windows on the oscilloscope. It can be seen in FIG. 22a that the signal is a 3-burst sinusoidal wave at f=150 kHz with 20 Vₚₚ. The amplification circuit generates a similar signal; however, it can be seen that the signal is actually a square wave with a peak-to-peak voltage of 24 V due to the ±12 V regulator (see FIG. 22b). After the third pulse, the signal is shunted to ground to prevent ringing, and this is included in the waveform that is uploaded to the transmission board.

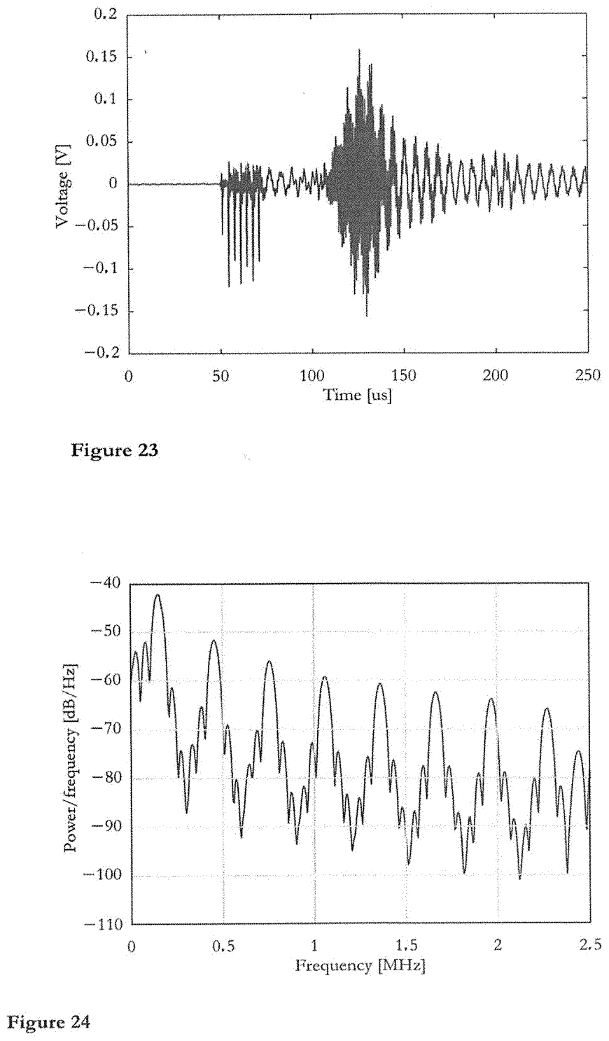

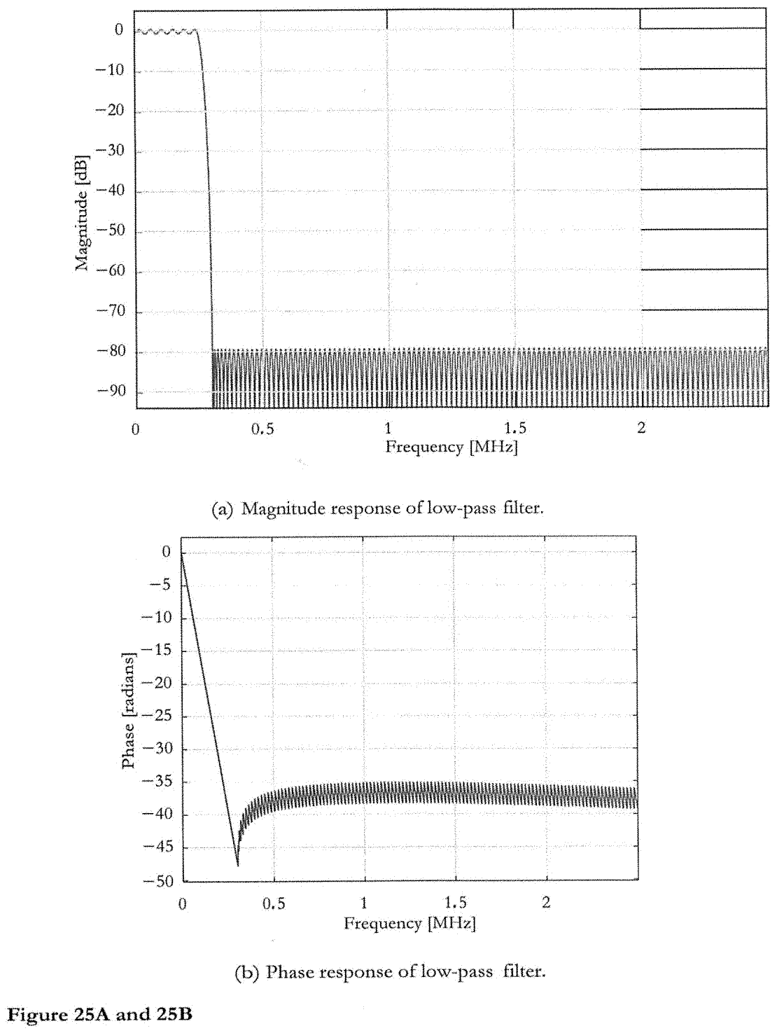

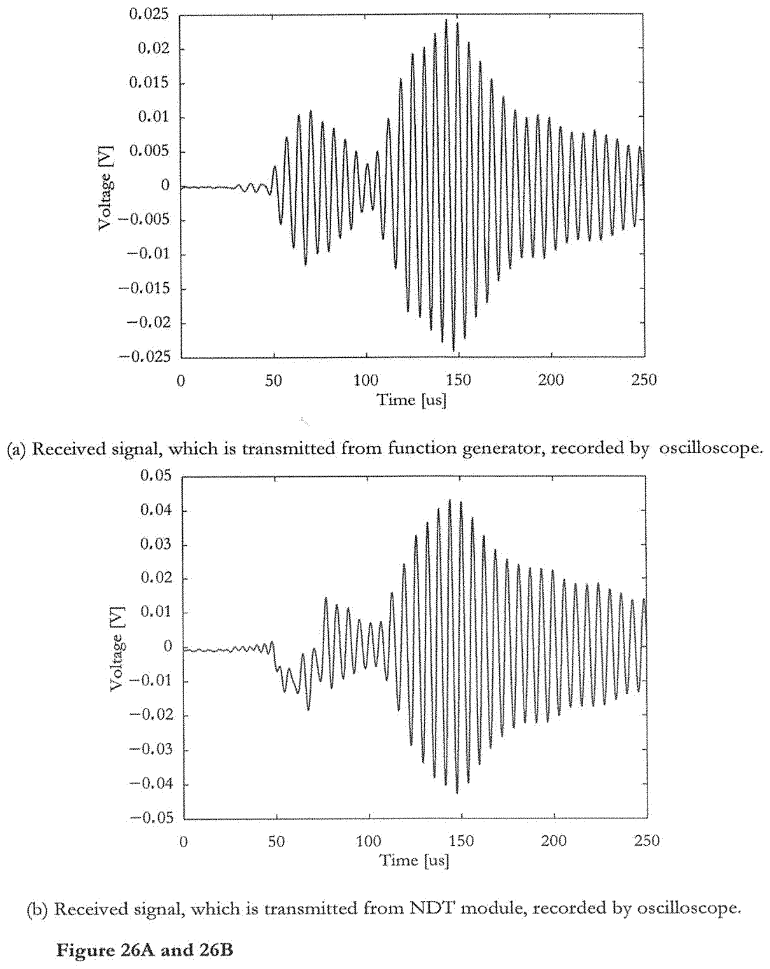

When using the benchtop waveform generator and oscilloscope, the experiments are repeated and the signals are averaged to increase the signal-to-noise ratio (SNR) with a built-in function. For the NDT module, the signal is programmed to be a single burst, so it must be transmitted multiple times to evaluate an average signal. For the probe locations 3 to 5, four signals are captured and averaged in MATLAB (see FIG. 23) While this process decreases the random noise in the signal, the overall signal remains the same in its relatively noisy state. To further increase the SNR and produce a smoother signal for NDT analysis, a finite-impulse response (FIR) equiripple low-pass filter is designed using the MATLAB filter designer. First, the power spectrum of the excitation signal is taken (see FIG. 24) It can be seen that the most power is at excitation frequency f=150 kHz, and because the excitation signal is a square wave, the harmonic frequencies can be identified by the subsequent peaks in the power spectrum. To exclude the harmonics, the pass frequency is set up to f=250 kHz and the stop frequency is set from f=300 kHz, which is the first local minimum before the next harmonic. The roll-off is kept at the default 80 dB since it is not possible to have an instantaneous cutoff for the filter. The magnitude and phase response plots of the filter can be seen in FIG. 25. It is noted that there is a linear phase shift, meaning there is no phase distortion. This results in a constant group delay of 126.5 samples for all frequencies because the low-pass filter is implemented in real-time. However, by using the filtfilt function in MATLAB, the filtered signal has zero-phase shift. [27]

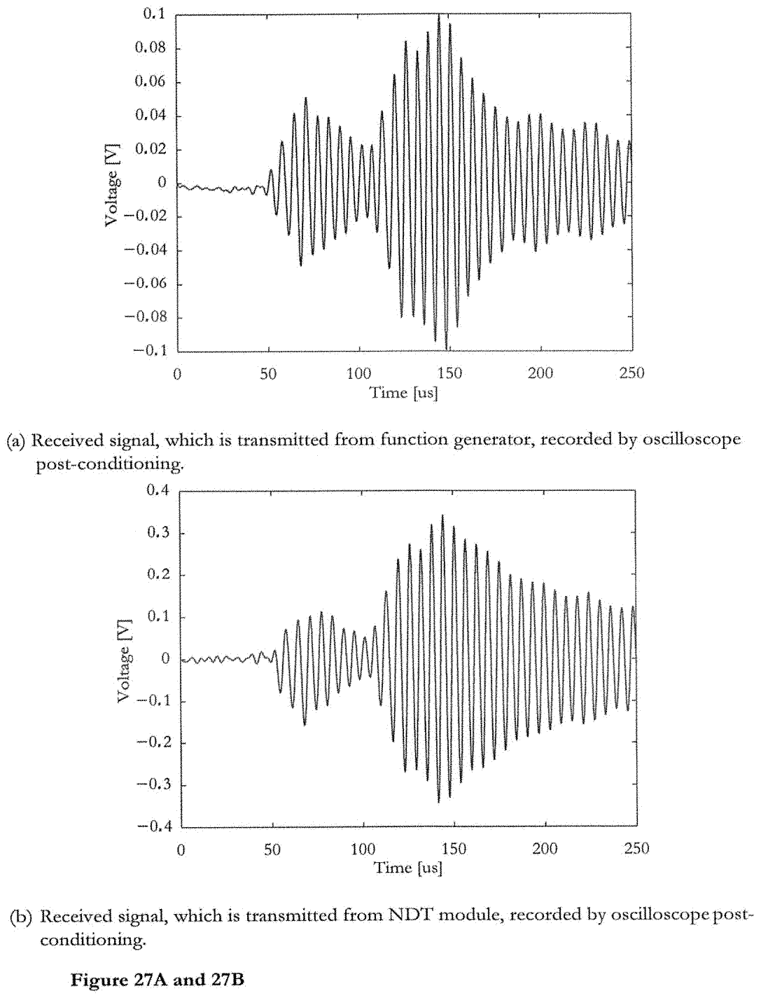

Next, signals from probe 3 are shown in FIG. 26. For these signals (and all following probe locations unless otherwise stated), the capture is triggered at 50 μs. These signals are captured before they are conditioned. All received signals have had the mean subtracted. In FIG. 26a, the first wave packet of interest has an approximate peak-to-peak voltage of Vₚₚ=0.05 V with the peak time of approximately 148 μs. All comparisons are based on this wave packet unless otherwise stated. From the amplification circuit on the NDT module (see FIG. 26b) the same wave packet has an approximate Vₚₚ=0.09 V, which is slightly higher due to the slightly larger peak-to-peak voltage of the NDT module's transmitted signal. This demonstrates the viability of using the amplification circuit on the robot.

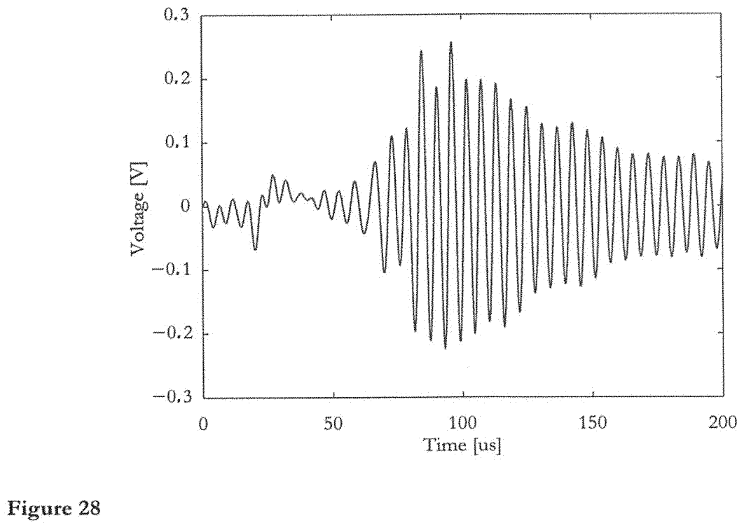

Two signals from probe 4 are shown in FIG. 27. These signals are captured after they pass through the conditioning circuit. The signal in FIG. 27a is transmitted from the function generator and has an approximate Vₚₚ=0.2 V. In FIG. 27b, the signal generated from the NDT module is shown, and there is an increase in amplitude, Vₚₚ=0.7 V, due to the amplification in the conditioning circuit. This demonstrates that the conditioning circuit on the NDT module is able to receive and condition signals.

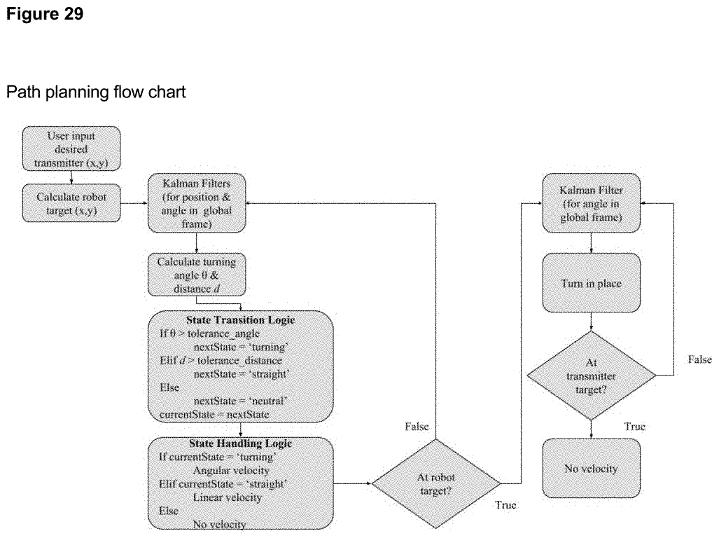

Finally, the signals captured from probe 5 are saved in the internal RAM of the microcontroller after the data is converted via the ADC see FIG. 28. Compared to the other probe locations plots, this signal is triggered at 0 μs, and the peak occurs around 100 μs.

As previously mentioned, to improve the quality of the signal, four signals are captured for each scenario and averaged (see FIG. 23) Additionally, the averaged signal is post-processed with a low-pass filter. To quantify the improvement by filtering the signals, the SNR is evaluated for both cases: unfiltered and low-pass filtered. To calculate the the SNR, the following equation from Matz et al. [28] is used:

$$SNR = 20 log \frac{( {S}_{ef} )}{( {N}_{ef} )} [ dB ] ,$$

where S_{ef} is the root mean square value of an adequate part of the filtered signal. In this case, three wave packets starting with the first packet of interest is used. N_{ef} is the root mean square value of the noisy part of the raw signal. The results can be seen in Table 6, in which it the SNR is shown in decibels. It is clear to see the low-pass filter makes an improvement. While this implementation was done in MATLAB, the low-pass filter can also be implemented in the NDT module's microcontroller.

TABLE 6
Signal-to-noise ratio improvements with low-pass filter.

| | SNR [dB] |
|---|---|
| Unfiltered | 16.56 |
| Low-pass filtered | 20.26 |

Because the electronics are able to transmit and receive the correct signals, this demonstrates the possibility of utilizing robot platforms for NDT measurements gathered using air-coupled transducers.

### Example 2

### Lamb Wave-Based Nondestructive Inspection Using A Mobile Robotic Platform

Guided wave-based methods are promising for efficient, large-scale testing. However, with many nondestructive testing (NDT) techniques, the accuracy and reliability is generally dependent on the operator's conduct. To bridge this gap, a preliminary design is implemented in this work that allows a mobile robot to perform NDT. The design implements an active guided wave-based method centered around air-coupled transducers used in a pitch-catch configuration. The on-board circuitry allows the robot to either output an amplified actuation signal or capture low-amplitude wave signals. In combination with odometry-type sensors, a map of the (unknown) structure, onto which the robot is deployed, is automatically created. During post-processing, any “hidden” structural features or defects can be identified and localized from the recorded guided wave signals. The unique combination of sensory information is demonstrated in laboratory experiments on unstiffened and stiffened aluminum plates. The feasibility of the robotic NDT, including the detection of a stiffener, is discussed by comparing the results to reference values and existing data from the literature. The results indicate that it is generally feasible to employ a mobile robotic platform to conduct guided wave-based NDT to create a map of an unknown surface.

In this Example, a mobile robot is used to perform NDT measurements on plates in order to detect edges, internal structural features, and to perform self-localization. That is, on-board odometry-type sensors are used to established an outline of the structure, and edge detection and self-localization are achieved through guided wave-based measurements and source localization techniques.³⁶ Furthermore, internal feature detection using guided ultrasonic waves is demonstrated for a reinforced aluminum panel.^{34, 35} The mobile robotic platform demonstrated in this work is based on the ideas of Miranda et al.⁴² The improved platform includes a new signal conditioning circuit in addition to other hardware enhancements, and platform's capabilities are demonstrated in comparison with measurements through laboratory equipment. Thus, this paper contributes to the successful implementation of future automated robotic NDT applications.

### Guided Waves and Feature Detection

In this Example, ultrasonic waves in form of Lamb waves are utilized for NDT and mapping purposes. Lamb waves are guided waves that exist in two fundamental forms, symmetric (S0) and anti-symmetric (A0) modes. The S0 and A0 waves have distinct velocities and displacement _elds, which can be utilized to distinguish between them. For this work, the A0 wave is selected due to the higher amplitudes when excited and measured at the surface of plate-like structures.

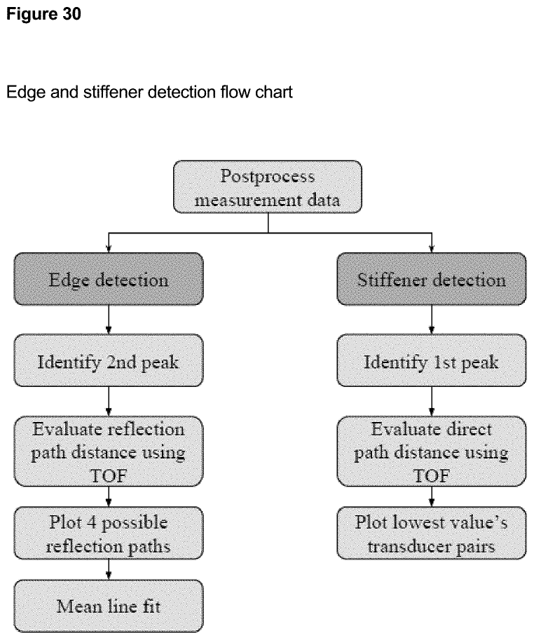

To determine the location of a mobile robot, guided wave-based source localization methods are implemented.³⁶ That is, to self-localize a mobile robot with respect to a stationary robot (here: a fixed sensor), an L-shaped cluster pattern can be used, as seen in FIG. 31A. This configuration allows for the distance D and angle Θ between cluster and sensor to be determined. Through a TOF analysis for the first A0 wave within signals captured for the three locations within each cluster, the direct actuator-sensor path can be evaluated, thus enabling self-localization. Utilizing the second (large) wave packet, i.e. the A0A0 wave, another (scattered) wave path can be evaluated. Here, it is assumed that this reaction must have occurred at the edge of the structure. Since the A0 wave reacts at the incident angle, an ellipse can be determined where the foci are the cluster center and the stationary robot's positions if the group velocity is known.⁴² Intersecting the path determined from the sensor cluster method with the ellipse results a “source” point on the edge. This method can be used at various locations to create a series of points that indicate the locations of the edges. It should be noted that for accurate results, the cluster center (∘) should be at least D=10 d away from the fixed sensor (+), where d is the distance between the cluster center and cluster points (.). For a further discussion of utilizing the source localization technique by Kundu et al.³⁶ for robotic applications, the reader is referred to a previous paper by the authors' research group.³⁴

To locate any internal structural features, such as stiffeners, the robot is assumed to perform measurements in a grid-like manner across the structure in conjunction with a stationary reference transducer. This scanning technique is used to determine anomalies between different wave paths.^{34, 35} Specifically, two features are extract from the wave signals: a) time of arrival and b) maximum wave amplitude. That is, if Lamb waves travel through a region with different properties (material or geometry), the wave will generally propagate at a different velocity depending on, for example, the thickness of the plate and stiffener.⁹ Hence, a TOF analysis of the entire path (unstiffened and stiffened) will result in a modified pseudo-velocity compared to a path that does not cross any stiffening feature. It should be noted that delays in the measurement and actuation are not compensated such that the determined “velocity” is not the true group velocity and is therefore labeled as pseudo-velocity. As with the velocity, the incident wave's amplitude is also reduced when scattering occurs at a stiffening feature.⁹ While material attenuation is assumed to be negligible, geometric spreading must be compensated by normalizing each signals' amplitude by 1 divided by the square root of r, where r is the distance between actuator and sensor.

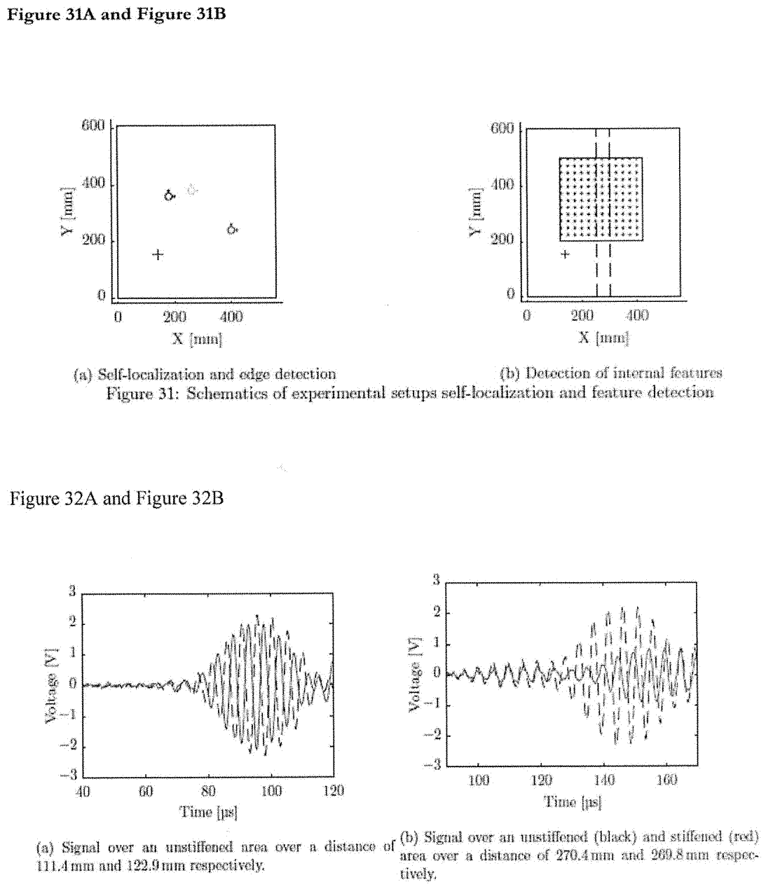

A brief comparison of sample signals captured in an unstiffened region of a plate as well as one that corresponds to waves crossing a stiffener is given in FIG. 32. From FIG. 32A, it can be seen that over two similar distances, the amplitude is identical when traveling through an unstiffened portion. Whereas, when traveling through a stiffened vs. unstiffened portion over similar distances, the wave that traveled through the stiffener lost about half its initial amplitude. Furthermore, substantial scattering effects and phase delays can be observed when comparing wave paths that cross a stiffener (red) versus those that do not (black), as shown in FIG. 32B. In summary, for each measurement location, magnitude and pseudo-velocity are extracted. Then, a k-means clustering algorithm is applied to this data, thus partitioning the data into k clusters.^{39, 40} The specific k-value is chosen based on an elbow method, which performs an analysis on a range of k-values. Once the clusters are determined, the group of outliers is determined based on physical considerations. That is, the cluster group with the lowest magnitude and highest pseudo-velocity is most likely representative of paths crossing the stiffened region. An additional statistical outlier rejection is performed before and after the k-means clustering. This scanning technique can be repeated for multiple stationary transducer locations and/or grid locations. By combining the information across all measurements, internal features can be identified as shown in this Example.

### Robotic Platform

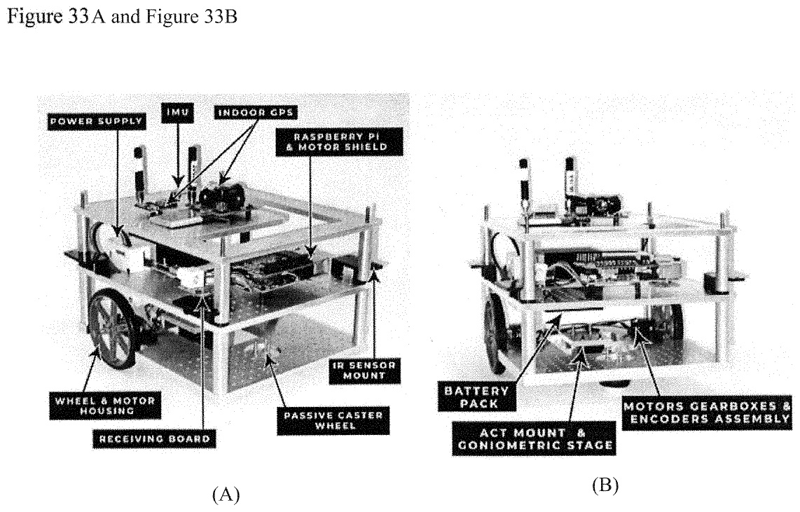

The developed prototype robotic platform is shown in FIGS. 33A and 33B. It should be noted that not all components and wires are included in these images for the sake of clarity. This custom mobile robotic platform is envisioned for conducting autonomous Lamb wave-based NDT and is an improved version of earlier work by the authors' research group.⁴² The dimensions of the robot are approximately 220 mm×190 mm×180 mm (L×W×H), and the weight is approximately 3 kg. The robot is constructed with machined 6061 T6 aluminum alloy, polymer 3D printed parts as well as off-the-shelf components. The drive-train consists of two brushed DC motors actuating 80 mm wheels configured in a differential drive setup, and one passive caster wheel. The DC motors are integrated with gearboxes consisting of a 1000:1 gear ratio and magnetic encoders. The robot is equipped with four infrared sensors used for cli_ detection. An inertial measurement unit (IMU) is used to determine the robot's heading, while an indoor GPS system is used for a general localization within the robot's work-space. The IMU is positioned to be aligned with the turning center of the wheel base. A Raspberry Pi serves as the actuator and sensor hub, executes the locomotion, and performs preliminary data processing for the NDT algorithms. Battery and power supply are custom designs are discussed in this Example.

Integrated into the robot is a custom-made mount for an air-coupled ultrasound transducer (ACT). The orientation of the robot controls the yaw angle of the ACT, while a goniometric stage is used to adjust the pitch angle according to the parameters needed for inspection. Required measurement circuitry that has been developed for this robotic platform, including amplification and signal conditioning circuits, are discussed in this Example.

### Custom Circuitry for Robotic NDT

In order to accommodate fully automated robotic NDT using guided waves, actuation and receiving circuitry is required. In this work, two main circuits have been developed and are presented in the following. Additionally, a custom power supply unit is discussed as well. Two-sided PCBs with mostly surface mount components are created to reduce board size and fatigue from vibration.

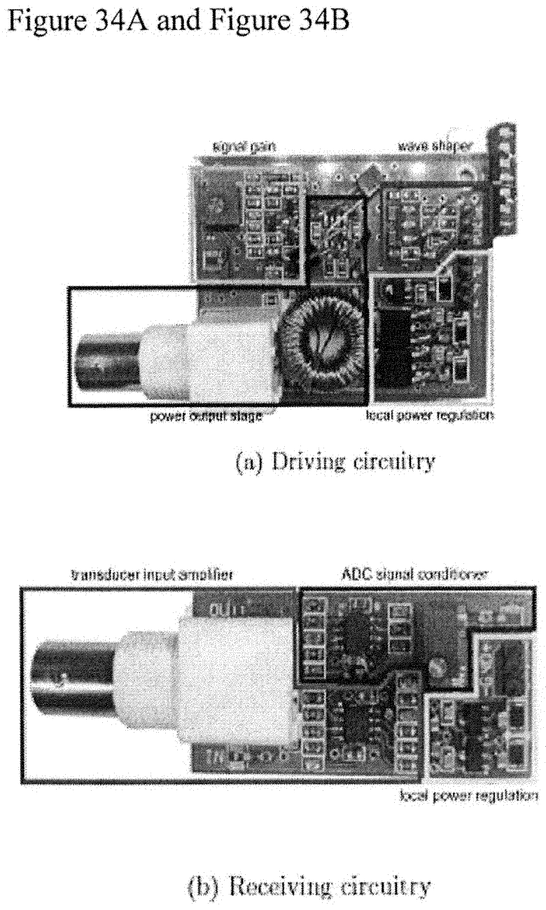

The driving circuitry is adapted from²⁹ and is shown in FIG. 34A. Actuation of the transducer is handled by a multistage circuit consisting of a wave shaper, signal gain and power output stage. First, a 250 kHz clock signal and synchronized gate pulse at 10 Hz are generated by the micro-controller. These two square waves are compared using a logical AND gate whose output defines the base shape of the transmission signal. A three-stage LC circuit progressively shapes the square waves into a symmetrical Hann wave. A gain stage built around three discrete transistors boosts the signal and splits it into bipolar voltages to drive the gate pins of an ON Semiconductor FDS4559 complementary MOSFET pair in a push-pull configuration. This MOSFET output stage is necessary for providing a high current to the step-up toroidal transformer that drives the output transducer via a BNC connector at ±60 V. Voltage regulation for the signal gain and power output stage is handled by LM78M12 and LM79M12 fixed-voltage linear regulators to reduce high load voltage spikes and 400 Hz switching frequency from the shared buck-boost power supply. An additional LM78L05 5V linear regulator is needed to power the AND gate for the wave shaper. A ground plane and additional decoupling capacitors are physically placed and electrically routed as close as possible to filter out noise. Despite these precautions, a sharp transition can be measured on the signal output of the MOSFETs when the signal switches between the high and low-side FET due to the minimum voltage required to trigger each gate. Considering the “natural” filtering that occurs in the piezoelectric transducers, the effects on wave generation are minimal.

The receiving circuitry is also adapted from²⁹ and is shown in FIG. 34B and can be considered a signal conditioning circuit (SCC). Initial reception of the transducer signal connected via BNC is handled by a two-stage signal amplification circuit designed around a high speed LM7372 dual operational amplifier. Each stage is configured with a 1.6 Hz cutoff filter and a theoretical gain of 23 resulting in a total gain of 529 for the transducer's signal to be read by an oscilloscope/ADC at a low signal to noise ratio. Any excess voltages from the piezoelectric transducer are clipped. It is assumed that the boosted signal from the ultrasound transducer are at max 1Vpp after the aforementioned gain stages. In order to utilize the full range of the ADC, the signal must be further increased and biased from 0V through a second LM7372. The output signal of this board is connected via a U.FL micro coaxial connector to the ADC. Similar to the driver board, local ±12V regulation is handled by LM78L12 and LM79L12 fixed-voltage linear regulators as well as a ground plane and decoupling capacitors. It should be noted that the mentioned ADC circuit will be presented in a future publication. A custom-built mobile power supply and battery pack is created. Both the driver and receiver modules require ±15V due to the required dropout voltage needed for linear voltage regulators to create a stable ±12 V. An additional 7V is needed for the driver's 5V linear voltage regulator and brushed motor drivers. The indoor GPS and Raspberry Pi and its associated sensors require 5 V; 3.3V modules derive power from the Raspberry Pi's GPIO header. The power supply is powered by four 2200 mAH rechargeable Li-ion batteries arranged in 2 S 1P resulting in two electrically isolated packs with nominal 7.2 V. Each pack is equipped with a 2 S Li-ion battery management protection board based on an ABLIC's S-8252 chip and four Hottech 8205A N-channel MOSFETs to allow for safe charging and discharging of each pack. A 3D printed, air-cooled enclosure ensures that the batteries are protected and cable managed. The dual battery pack has two male JST connectors that mate with the two female JST connectors on the 3D printed enclosure for the switch mode power supply module. Both battery pack inputs, as well as the ±15 V, 7 V, and 5V output voltages are monitored by an Arduino Nano. An off-the-shelf switch-mode buck converter is used for the 5V rail while the other rails are created using an XLSEMI XL6009E1 in a SEPIC inverting buck-boost topology with a custom wound toroidal transformer. Using the XL6009E1 in buck-boost is necessary due to the battery voltage swinging between 5.6V to 8.4 V. The XL6009E1 is designed to regulate a single voltage rail via a feedback pin. To create three voltage rails, four separate coils are needed on the same ferrite toroid. Two coils of equal wire length and gauge are used to create a 47 μH inductor capable of 4 A for the buck-boost topology and provide the feedback voltage to generate a regulated high current 7V rail. The ±15V rails are created by adding two additional coils with a wire length 2.15 times longer than the primary coils. Since the output of the two additional coils are not monitored by the XL6009E1, their voltage is proportional to the current draw of the 7V rail meaning that high loads like motors can influence the ±15V rails. This problem is mitigated by local regulation and filtering on the boards requiring the affected rails. If any issues are detected by the Arduino on any of the rails, a warning message is triggered, and the XL6009E1 is shutdown. All outputs are accessed via 0.1″ headers and require a custom keyed wiring harness.

### Laboratory Setup for Preliminary Measurements

In this Example, preliminary guided wave testing is done using a pair of transducers configured in a pitch-catch configuration without the use of the presented robotic platform. Feature detection utilizes an air-coupled transducer (Sonotec CF 200) acting as the actuator and a contact transducer (Digitalwave B-454) acting as a sensor. Edge detection, localization, and as well as circuitry tests are demonstrated with a pair of contact transducers. A 6-cycle Hann-windowed wave burst is excited at 218 kHz for all experimental setups using a function generator (Keysight 33500B). The respective wave signals are digitized with an oscilloscope (Cleverscope CS320A) and time-average to improve the signal-to-noise ratio (SNR).

Three experimental setups are used in this research. The first setup (self-localization and edge detection) utilizes a cluster arrangement (d=20 mm) on a 610 mm×610 mm×3.175 mm pristine unstiffened aluminum plate (see FIG. 31A). The second setup (stiffener detection) utilizes an xy-positioning system to create a 300 mm×300 mm grid with a 25 mm×25 mm incremental step on a 610 mm×558 mm×3.175 mm pristine stiffened aluminum plate (see FIG. 31B). The stiffener consists of a 610 mm×50 mm×3.175 mm piece made from the same aluminum plate. The stiffener is attached at the center of the plate using 24 screws tightened at 1.12 N-m. Six test locations are utilized to locate the stiffener. These two setups employ a power amplifier (E&I 2100L Broadband Amplifier) to amplify the driving voltage to 258 Vpp as well as a gain filter (Krohn-hite Model 3988) to further improve the SNR. The third setup (circuit performance) employs two CTs centrally located on a pristine aluminum plate. Laboratory equipment is systematically replaced with the developed custom circuitry and their performance is evaluated and compared.

### Results

### Demonstration of NDT Circuitry

To determine the possibility of mobile measurements, the performance of the custom NDT circuitry is evaluated. It should be noted that the scope of this work only allowed for the testing of the first stage of the signal conditioning circuit. To this end, a set of two CTs is placed in the center of a pristine aluminum plate as discussed in this Example. For each setup, a consistent number of time averages is taken to improve the overall SNR.

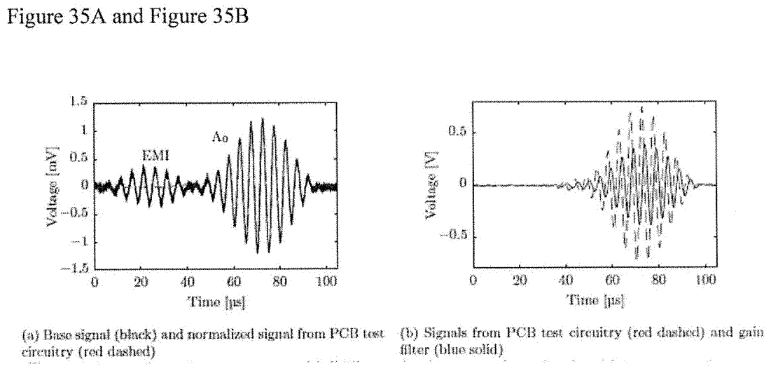

In FIG. 35A, a raw measurement (black) without power amplification or signal conditioning is shown. It can be seen that the peak-to-peak voltage for the wave packet of interest, labeled as A0, is only 2.3 mVpp, and the peak of this wave packet is detected at 73.1 μs. The SNR in this case is determined as 1.4 dB. Then, the signal conditioning circuit is added between the sensor and the oscilloscope. A new measurement is taken and the amplitude is increase to 1.22 Vpp and the SNR to 45.3 dB. As can be seen from FIG. 35A, where the new signal (red dashed) is maximum normalized to match the scale of the raw signal, the first stage of the conditioning circuit has a near zero-delay when compared to the base signal. Additionally, the conditioned signal is also compared to that when the circuit is replaced with a laboratory-type gain filter. As shown in FIG. 35B, the signal captured through the custom circuit (dashed) has a comparable amplitude and SNR but does not suffer the delay that the gain filter (solid line) introduces. Once stage 2 of the custom circuit is implemented, a similar delay is expected due to the additional filtering. It should also be noted that the gain filter is adjusted to approximately match the custom circuit's resultant magnitude, while a band pass of 10-800 kHz is used. A summary of the determined measurement characteristics are given in Table 7.

| | Raw | Gain filter | Receiving circuit |
|---|---|---|---|
| Amplitude [Vₚₚ] | 0.0023 | 0.78 | 1.22 |
| SNR [dB] | 1.4 | 41.8 | 45.3 |
| Time of arrival [μs] | 73.1 | 74.3 | 72.6 |

### Demonstration of Internal Feature Detection

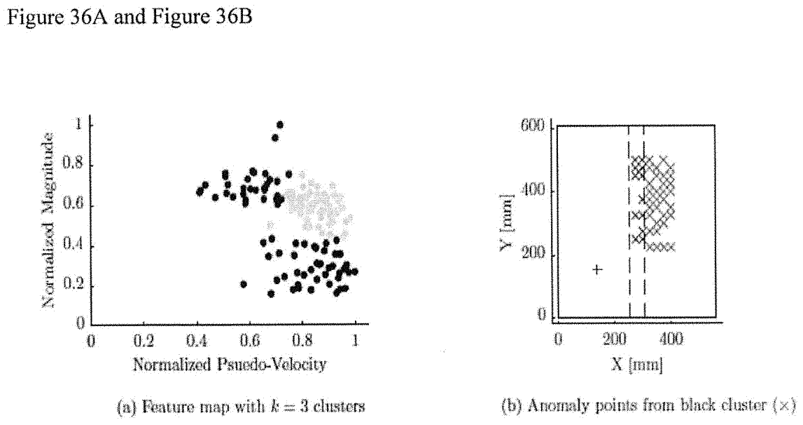

As discussed in this Example, a k-means clustering algorithm is employed to identify anomalies to extract features (here: magnitude and pseudo-velocity) that are sensitive to changes in material of geometry, such as in the case of a stiffener. Measurements are taken on a stiffened aluminum panel as described in this Example, and feature maps are generated for k=3. A representative sample feature map is shown in FIG. 36A. For the present stiffener, it is expected that amplitudes are lower and waves arrive faster as compared to the unstiffened case.⁹ Thus, only measurement locations from the black cluster are used for further processing. As shown in FIG. 36B, these locations (x) correspond to those on (blue) or “after” (magenta) the stiffener in reference to the stationary transducer location (+).

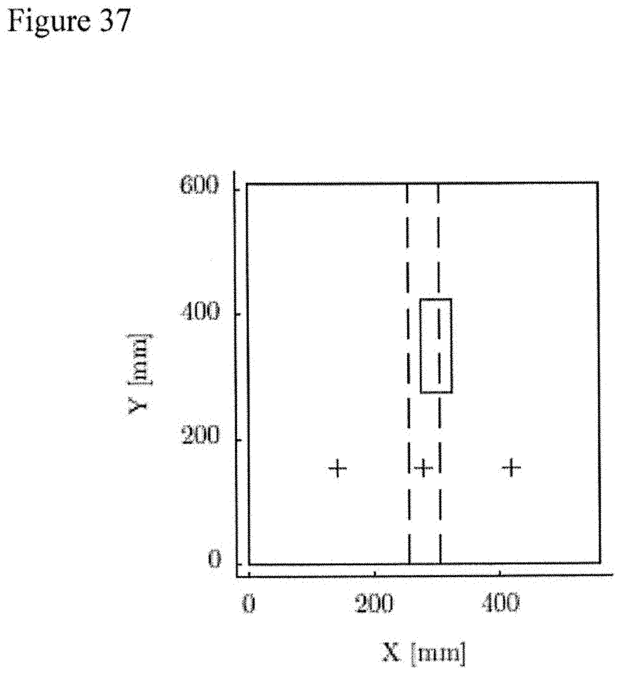

This process is repeated for a total of six combinations of transducer-grid locations. In particular, the stationary transducer is once placed left, on, and right of the stiffener, while the grids are positioned either slightly shifted to the left or right of the stiffener. A total of 864 measurements is taken and evaluated. In order to determine a stiffener location, the intersection of all anomaly maps is taken, which results in an approximation of the location and width (size) of the stiffened area as shown in FIG. 37. By means of this process, a partial localization/identification of the stiffening feature is achieved (58% true positive). It can be seen, however, that the estimated area is skewed towards the right.

### Demonstration of Self-Localization and Edge Detection

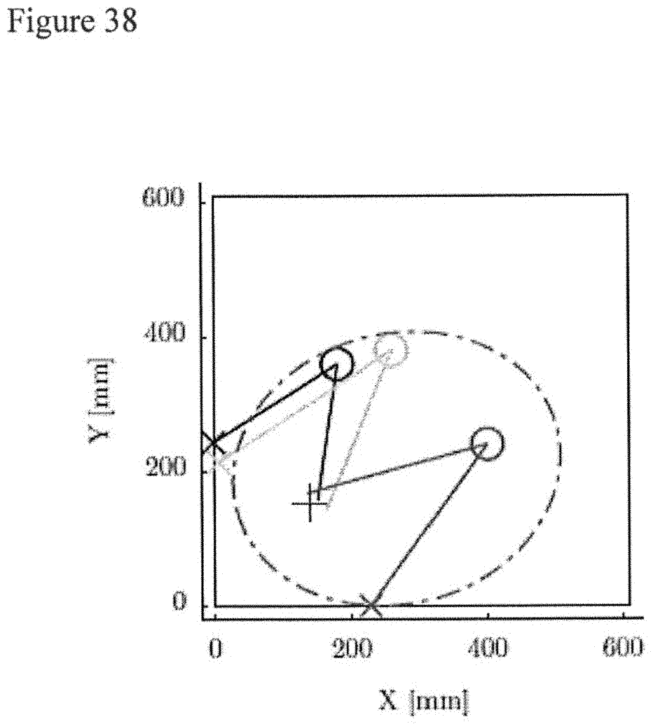

The proposed self-localization and edge detection methods from earlier in this Example are based on cluster patterns (∘), where the A0 group velocity is determined as 3378 m/s. The methods' performance is evaluated by determining the Euclidean distance Δ to the true location. A total of three clusters is utilized for each goal, and the results are shown in FIG. 38.

The smallest error in the estimated position of the reference sensor (+) occurs for cluster C1 (blue) and is Δ=11:1 mm, while the largest is Δ=25:9 mm for cluster C2 (green). This error range is comparable to that of the robotic platform's off-the-shelf indoor GPS system (±2 cm). It should also be noted that it was found that a 45° relative to the L-shaped cluster generally produces the most accurate results.³⁴ In other words, this may lead to a time-dependent error when considering a multi-robot system that is scanning a structure. Similarly, when the second wave packet is evaluated, reection points from edges of the plate can be determined. An ellipse is used to locate the edge with the cluster center and sensor location as the foci. One sample ellipse (magenta) and three estimated reflection points (x) are shown in FIG. 38. It can be seen that due to the location of the clusters, C1 and C2 identify a point on the left edge, while C3 identifies a point on the bottom edge of the plate. The performance for locating the edges is similar to that of the self-localization. Cluster C1 leads to the smallest error while cluster C2 identifies a point that is furthest from its theoretical reflection point. A summary of all results for self-localization and edge detection can be found in Table 8.

| | Estimated distance [mm] | | Error Δ [mm] | |
|---|---|---|---|---|
| Cluster # | Reference sensor | Edge point | Sensor | Edge |
| C1 (blue) | 205.5 | 216.7 | 11.1 | 2.4 |
| C2 (green | 256.7 | 228.1 | 25.9 | 20.4 |
| C3 (magenta) | 275.3 | 363.4 | 15.2 | 12.8 |

### REFERENCES

[1] C. Ramadas, K. Balasubramaniam, M. Joshi, and C. V. Krishnamurthy. Interaction of guided Lamb waves with an asymmetrically located delamination in a laminated composite plate. Smart Materials and Structures, 19(6):065009, 2010. doi: 10.1088/0964-1726/19/6/065009.

[2] C. Schaal and A. Mal. Core-skin disbond detection in a composite sandwich panel using guided ultrasonic waves. Journal of Nondestructive Evaluation, Diagnostics and Prognostics of Engineering Systems, 1(1): 011006, 2017. doi: 10.1115/1.4037544.

[3] W. Ewing, W. Jardetzky, and F. Press. Elastic Waves in Layered Media. McGraw-Hill, New York, 1957.

[4] L. Brekhovskikh. Waves in Layered Media. Academic Press, New York, N.Y., 1960.

[5] N. Vasudevan and A. Mal. Response of an elastic plate to localized transient sources. Journal of Applied Mechanics, 52(2):356-362, 1985. doi: 10.1115/1.3169053.

[6] N. Guo and P. Cawley. The interaction of lamb waves with delaminations in composite laminates. The Journal of the Acoustical Society of America, 94(4):2240-2246, 1993. doi: 10.1121/1.407495.

[7] G. Shkerdin and C. Glorieux. Lamb mode conversion in a plate with a delamination. The Journal of the Acoustical Society of America, 116(4):2089-2100, 2004. doi: 10.1121/1.1784435.

[8] C. Schaal, S. Zhang, H. Samajder, and A. Mal. An analytical study of the scattering of ultrasonic guided waves at a delamination-like discontinuity in a plate. Proceedings of the Institution of Mechanical Engineers, Part C: Journal of Mechanical Engineering Science, pages 1-14, 2017. doi: 10.1177/0954406217700176.

[9] C. Schaal and A. Mal. Lamb wave propagation in a plate with step discontinuities. Wave Motion, 66: 177-189, 2016. ISSN 0165-2125. doi: 10.1016/j.wavemoti.2016.06.012.

[10] D. C. Gazis and R. D. Mindlin. Extensional vibrations and waves in a circular disk and a semi-infinite plate. Journal of applied mechanics, 27(3):541-547, 1960.

[11] P. J. Torvik. Reflection of wave trains in semi-infinite plates. The Journal of the Acoustical Society of America, 41(2):346-353, 1967. doi: 10.1121/1.1910344.

[12] Y. Cho and J. L. Rose. A boundary element solution for a mode conversion study on the edge reflection of lamb waves. The Journal of the Acoustical Society of America, 99(4):2097-2109, 1996. doi: 10.1121/1.415396.

[13] O. Diligent, M. J. S. Lowe, E. Le ClÃl'zio, M. Castaings, and B. Hosten. Prediction and measurement of nonpropagating lamb modes at the free end of a plate when the fundamental antisymmetric mode a0 is incident. The Journal of the Acoustical Society of America, 113(6):3032-3042, 2003. doi: 10.1121/1.1568758.

[14] S. Santhanam and R. Demirli. Reflection of Lamb waves obliquely incident on the free edge of a plate. Ultrasonics, 53(1):271-282, 2013. ISSN 0041-624X. doi: 10.1016/j.ultras.2012.06.011.

[15] L. Gavrić. Computation of propagative waves in free rail using a finite element technique. Journal of Sound and Vibration, 185(3):531-543, 1995. ISSN 0022-460X. doi: 10.1006/jsvi.1995.0398.

[16] S. Finnveden. Spectral finite element analysis of the vibration of straight fluid-filled pipes with flanges. Journal of Sound and Vibration, 199(1):125-154, 1997. ISSN 0022-460X. doi: 10.1006/jsvi.1996.0602.

[17] B. R. Mace, D. Duhamel, M. J. Brennan, and L. Hinke. Finite element prediction of wave motion in structural waveguides. The Journal of the Acoustical Society of America, 117(5):2835-2843, 2005. doi: 10.1121/1.1887126.

[18] H. Baid, C. Schaal, H. Samajder, and A. Mal. Dispersion of Lamb waves in a honeycomb composite sandwich panel. Ultrasonics, 56(0):409-416, 2015. ISSN 0041-624X. doi: 10.1016/j. ultras.2014.09.007.

[19] K. F. Graff. Wave Motion in Elastic Solids. Dover Publications, Mineola, N.Y., 1991. ISBN 978-0486667454.

[20] A. K. Mal and S. J. Singh. Deformation of Elastic Solids. Prentice Hall New Jersey, 1991.

[21] C. Schaal, X. Cao, and A. Mal. The Influence of Stiffeners on the Propagation of Guided Ultrasonic Waves. In Proceedings of the 10th International Workshop on Structural Health Monitoring—IWSHM, Palo Alto, Calif., USA, 2015. doi: 10.12783/SHM2015/248.

[22] C. Schaal, S. Bischoff, and L. Gaul. Damage detection in multi-wire cables using guided ultrasonic waves. Structural Health Monitoring, 15(3):279-288, 2016. doi: 10.1177/1475921716647249.

[23] K. Worden. Rayleigh and Lamb Waves—Basic Principles. Strain, 37(4):167-172, 2001.

[24] P. Kim. Kalman Filter for Beginners: with MATLAB Examples. CreateSpace, 2011.

[25] P. E. Rybski. Mobile Robot Localization and Mapping using the Kalman Filter. Lecture Notes, 2003.

[26] J. P. Holman and W. J. Gajda. Experimental methods for engineers, volume 2. McGraw-Hill New York, 2001.

[27] A. V. Oppenheim. Discrete-Time Signal Processing. Pearson Education India, 1999.

[28] V. Matz, M. Kreidl, and R. Smid. Classification of ultrasonic signals. International Journal of Materials and Product Technology, 27(3-4): 145-155, 2006.

[29] A. Pertsch, J.-Y. Kim, Y. Wang, and L. J. Jacobs. An intelligent stand-alone ultrasonic device for monitoring local structural damage: implementation and preliminary experiments. Smart Materials and Structures, 20(1):015022, 2010.

[30] Castaings, M. and Cawley, P., “The generation, propagation, and detection of lamb waves in plates using air-coupled ultrasonic transducers,” The Journal of the Acoustical Society of America 100(5), 3070{3077 (1996).

[31] D E Barros, S., Gama, A. L., Rousseau, M., and Collet, B., “Characterization of bonded plates with lamb and sh waves using a quasi-static approximation,” Latin American Journal of Solids and Structures 1(4), 379{399 (2004).

[32] Ostachowicz, W., Radzienski, M., Kudela, P., and Jurek, M., “Non-contact excitation of guided waves using air-coupled ultrasonic transmitters for damage detection,” in [Nondestructive Characterization and Monitoring of Advanced Materials, Aerospace, Civil Infrastructure, and Transportation XIII], 10971, 109711 J. International Society for Optics and Photonics (2019).

[33] Su, Z., Ye, L., and Lu, Y., “Guided Lamb waves for identification of damage in composite structures: A review,” Journal of sound and vibration 295(3-5), 753{780 (2006).

[34] Schaal, C., Brown, M., and Schulz, K., “Experimental investigation of lamb wave-based edge detection methods,” Proc. SPIE 10972, 1097223{1097223{11 (2019).

[35] Hong, E. and Schaal, C., “Reverse engineering stiffened plates using guided wave-based nondestructive testing methods,” Proc. SPIE 10600, 10600{10600{9 (2018).

[36] Kundu, T., Nakatani, H., and Takeda, N., “Acoustic source localization in anisotropic plates,” Ultrasonics 52(6), 740{746 (2012).

[37] Sen, N., Gawronski, M., Packo, P., Uhl, T., and Kundu, T., “Acoustic source localization in anisotropic plates without knowing their material properties: an experimental investigation,” in [Health Monitoring of Structural and Biological Systems XIII], 10972, 1097224, International Society for Optics and Photonics (2019).

[38] Forgy, E. W., “Cluster analysis of multivariate data: efficiency versus interpretability of classifications,” Biometrics 21, 768{769 (1965).

[39] Morissette, L. and Chartier, S., “The k-means clustering technique: General considerations and implementation in mathematica,” Tutorials in Quantitative Methods for Psychology 9(1), 15{24 (2013).

[40] Qi, J., Yu, Y., Wang, L., Liu, J., and Wang, Y., “An effective and efficient hierarchical k-means clustering algorithm,” International Journal of Distributed Sensor Networks 13(8), 1550147717728627 (2017).

[41] Bouzenad, A. E., El Mountassir, M., Yaacoubi, S., Dahmene, F., Koabaz, M., Buchheit, L., Ke, W., et al., “A semi-supervised based k-means algorithm for optimal guided waves structural health monitoring: A case study,” Inventions 4(1), 17 (2019).

[42] Miranda, A., Gonzales, C., Balyan, A., and Schaal, C., “Mobile Robotic Platform for Inspecting Aircraft Surfaces Using Lamb Waves,” in [Proceedings of the 12th International Workshop on Structural Health Monitoring {IWSHM], (2019).

Thus, specific embodiments of robotic platforms and robots for nondestructive testing applications, including their production and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A robotic platform, comprising:
at least one robot or robotic device, wherein the at least one robot or robotic device comprises a sensor for cliff detection,
at least one computer-based control system, wherein the system is at least in part located on the at least one robot,
at least one communications system, wherein the communications system is designed to communicate between the computer-based control system and the at least one robot, and
at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

2. The robotic platform of claim 1, wherein the at least one communications system is designed to communicate remotely between the at least one robot and a home base component, a user, or a combination thereof.

3. The robotic platform of clam 1, further comprising a structure that is separate and independent from the robotic platform, wherein the structure has at least one surface.

4. The robotic platform of claim 1, wherein the at least one computer-based control system comprises at least one path-planning algorithm.

5. The robotic platform of claim 4, wherein the at least one path-planning algorithm directs the at least one computer-based control system to drive the at least one robot or robotic device autonomously.

6. The robotic platform of claim 1, wherein the at least one evaluation system collects measurements on the structure.

7. The robotic platform of claim 1, wherein the at least one evaluation system conducts nondestructive tests on the structure.

8. The robotic platform of claim 1, wherein the at least one evaluation system collects at least one data point that will be used to produce a map of the structure.

9. The robotic platform of claim 1, wherein the map of the structure shows at least one edge, at least one defect, at least on damaged area, at least one additional structural problem, or a combination thereof.

10. The robotic platform of claim 1, wherein the at least one evaluation system collects at least one data point that will be used for stiffener detection on the surface.

11. The robotic platform of claim 9, wherein the at least one additional structural problem comprises a structurally weak area, an area that comprises an undesirable or unsuitable material, or a combination thereof.

12. The robotic platform of claim 1, wherein the at least one robot comprises a wheeled robot or a robot that is mobile by any other suitable means or methods.

13. The robotic platform of claim 1, wherein the at least one robot comprises at least one sensor.

14. A method of evaluating a surface, the method comprising:
providing a robotic platform that comprises:
at least one robot or robotic device, wherein the at least one robot or robotic device comprises a sensor for cliff detection,
at least one computer-based control system, wherein the system is at least in part located on the at least one robot,
at least one communications system, wherein the communications system is designed to communicate between the computer-based control system and the at least one robot, and
at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure;
providing a structure to be tested; and
utilizing the robotic platform in direct contact with the surface to evaluate the structure through the implementation of at least one nondestructive testing method.

15. The method of claim 14, wherein the at least one communications system is designed to communicate remotely between the at least one robot and a home base component, a user, or a combination thereof.

16. The method of claim 14, further comprising a structure that is separate and independent from the robotic platform, wherein the structure has at least one surface.

17. The method of claim 14, wherein the at least one computer-based control system comprises at least one path-planning algorithm.

18. The method of claim 16, wherein the at least one path-planning algorithm directs the at least one computer-based control system to drive the at least one robot or robotic device autonomously.

19. A robotic platform, comprising:
at least one robot or robotic device,
at least one computer-based control system, wherein the system is at least in part located on the at least one robot,
at least one communications system, wherein the communications system is designed to communicate between the computer-based control system and the at least one robot, and
at least one evaluation system that is designed to implement and process at least one nondestructive testing method, wherein the at least one evaluation system evaluates the structure for at least one damaged area that cannot be visually detected from the surface of the structure, at least one defect that cannot be visually detected from the surface of the structure, or at least one additional structural problem that cannot be visually detected from the surface of the structure.

20. The robotic platform of claim 18, wherein the at least one communications system is designed to communicate remotely between the at least one robot and a home base component, a user, or a combination thereof.
